(19) United States
(12) Patent Application Publication
(10) Pub. No.: US 2025/0179305 A1
(43) Pub. Date: Jun. 5, 2025

(54) LASER MARKABLE RESIN COMPOSITIONS FOR ORTHODONTIC APPLIANCES

(71) Applicant: Align Technology, Inc., San Jose, CA (US)

(72) Inventors: Adam LEUNG, San Jose, CA (US); Liang CHEN, Fremont, CA (US)

(21) Appl. No.: 18/960,401

(22) Filed: Nov. 26, 2024

Related U.S. Application Data
(60) Provisional application No. 63/604,619, filed on Nov. 30, 2023.

(51) Int. Cl. C09D 4/00; A61C 7/08; B29C 64/124; B29K 509/00; B33Y 10/00; B33Y 70/00; B33Y 80/00; B41M 5/26; B41M 5/333; B41M 5/46; C08K 3/04; C08K 3/22; C08K 3/36; C08K 5/00; C09D 7/41; C09D 7/61; C09D 7/63; C09D 133/10; C09D 135/02

(52) U.S. Cl. CPC C09D 4/00; A61C 7/08; B33Y 70/00; B33Y 80/00; B41M 5/267; B41M 5/3331; B41M 5/465; C09D 7/41; C09D 7/61; C09D 7/63; C09D 133/10; C09D 135/02; B29C 64/124; B29K 2509/00; B33Y 10/00; B41M 2205/32; C08K 3/041; C08K 2003/2248; C08K 2003/2296; C08K 3/36; C08K 5/0041; C08K 5/0091; C08K 2201/011

(57) ABSTRACT

This disclosure provides laser markable polymerizable resin compositions comprising infrared absorbing marking additives to achieve improved laser markability of 3-D printed objects obtained from these polymerizable resin composition, and methods for marking the cured resin compositions using an infrared laser.

### CROSS-REFERENCE TO RELATED APPLICATION

This application claims the priority of U.S. Provisional Patent Application No. 63/604,619, filed Nov. 30, 2023, which is hereby incorporated by reference in its entirety.

### BACKGROUND OF THE INVENTION

Orthodontic treatments involve repositioning misaligned teeth and improving bite configurations for improved cosmetic appearance and dental function. Repositioning is accomplished by applying gentle controlled forces to the teeth over an extended period of time. Due to the limited space within the oral cavity and the extensive movements that some teeth may undergo, the teeth will often be moved through application of a series of intermediate dental appliances to properly arrange the teeth. Additive manufacturing or three-dimensional (3D) printing is a process of making a 3D object of virtually any shape from a digital mode. Additive manufacturing involves depositing successive layers of material in different cross-sectional shapes and is widely utilized for fabricating orthodontic appliances using photopolymerizable materials.

Specific orthodontic appliances often need to be utilized in a particular sequence and tailored to individual users. One such appliance is the Invisalign® system available from Align Technology, Inc. The Invisalign® system includes removable aligners designed for patient use. These aligners are typically clear or transparent polymer orthodontic devices that are removably positioned over the teeth of the maxilla and/or the teeth of the mandible. During treatment, the patient replaces one aligner, calibrated for a specific stage, with another designed for the next stage. Each aligner incrementally moves the teeth toward their predetermined or aesthetically optimal position. There is a growing need to mark aligners for purposes such as identifying their sequence, patient information, or similar details.

### SUMMARY OF THE INVENTION

Provided herein are ultraviolet (UV) light curable (i.e., polymerizable) resin compositions comprising infrared (IR) absorbing marking additives that allow IR laser marking of orthodontic appliances formed therefrom with improved performance, methods of forming the orthodontic appliances, and method of marking the orthodontic appliances using IR radiation. The improved IR laser marking performance is achieved by a synergistic effect of using IR absorbing marking additives in combination with aliphatic, cyclophiphatic, or aromatic reactive diluents in the polymerizable resin compositions.

In one aspect, a polymerizable resin composition for forming an orthodontic appliance by additive manufacturing is provided. The polymerizable resin composition comprises a telechelic compound comprising an oligomeric or a polymeric chain of interconnected monomeric units having a first terminal end and a second terminal end. The oligomeric or polymeric chain is selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ester and (poly)urethane; at least one first reactive functional group covalently bonded to the first terminal end; and at least one second reactive functional group covalently bonded to the second terminal end. The polymerizable resin composition further comprises a reactive diluent and an infrared absorbing marking additive.

In some embodiments, the reactive diluent is an aliphatic or cycloaliphatic (meth)acrylate compound. In some embodiments, the reactive diluent is 2-ethylhexyl methacrylate (EHMA), 2-cyanoethyl methacrylate (CEMA), cyclohexyl methacrylate or isobornyl methacrylate (IBOMA). In some embodiments, the reactive diluent is an aromatic (meth)acrylate compound. In some embodiments, the reactive diluent has a molecular weight of 0.1 to 1.0 kDa and a vapor pressure of no greater than 12 Pa at 60° C. In some embodiments, the reactive diluent is a compound of Formula (III):

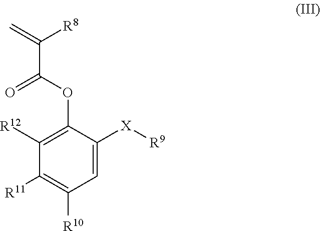

wherein: X is O, S, NR¹³, or SiR¹⁴R¹⁵; R⁸ is H, C₁₋₃ alkyl or halogen; R⁹ is H, C₁₋₆ alkyl, C₁₋₆ heteroalkyl, C₁₋₆ carbonyl, C₁₋₆ carboxy, cyclo(C₃₋₈) alkyl, cyclo(C₃₋₈) heteroalkyl, aryl or heteroaryl; R¹⁰ is H or aryl; R¹¹ and R¹² are each independently H, C₁₋₆ alkyl, C₁₋₆ heteroalkyl, C₁₋₆ alkoxy, C₁₋₆ thioalkoxy, C₁₋₆ carbonyl, C₁₋₆ carboxy, or —Y—(CH₂)ₙ—R¹⁶; or R¹¹ and R¹² together form aryl or heteroaryl; Y is O, S, NH orC(O)O; n is an integer from 0 to 6; R¹³, R¹⁴, and R¹⁵ are independently, H or C₁₋₆ alkyl; and R¹⁶ is cyclo(C₃₋₈) alkyl, cyclo-(C₃₋₈) heteroalkyl, aryl or heteroaryl.

In some embodiments, the reactive diluent has one of the following structures:

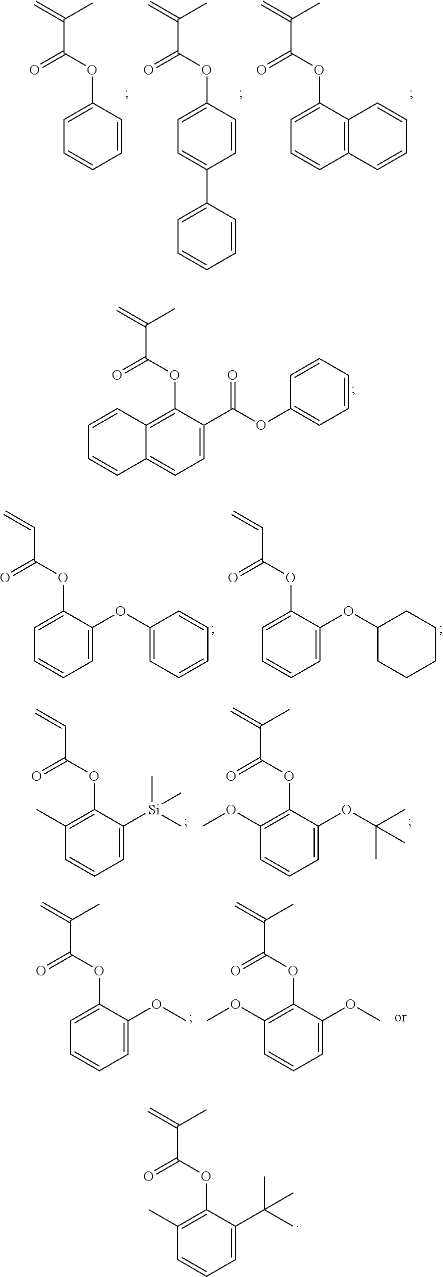

In some embodiments, the reactive diluent has one of the following structures:

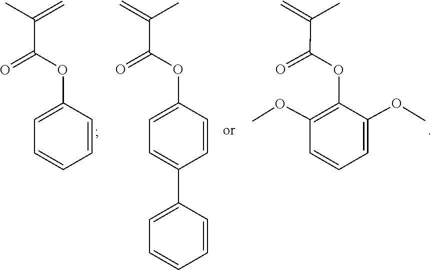

In some embodiments, the infrared absorbing marking additive comprises a silicate, a metal silicate, a carbon-based calcined material, a metal oxide, a transition metal hydroxide, a metal carbonate, a metal complex, a zeolite nanoparticle or combinations thereof. In some embodiments, the infrared absorbing marking additive is a metal oxide selected from the group consisting of copper oxide, chromium oxide, iron oxide, zinc oxide, tungsten oxide, molybdenum oxide and combinations thereof. In some embodiments, the infrared absorbing marking additive is a metal complex selected from the group consisting of copper phthalocyanine, zinc phthalocyanine, magnesium phthalocyanine, nickel phthalocyanine, iron phthalocyanine and combinations thereof. In some embodiments, the infrared absorbing marking additive is a carbon-based calcined material selected from the group consisting of carbon black, graphene, carbon nanotube and combinations thereof.

In some embodiments, the at least one first reactive functional group and the at least one second reactive functional group is selected from acrylate, methacrylate, vinyl acrylate, vinyl methacrylate, allyl ether, silene, alkyne, alkene, vinyl ether, maleimide, fumarate, maleate, itaconate, vinyl ester, vinyl ketone, epoxide, oxetane, cyclic ester, and styrenyl.

In some embodiments, the at least one first reactive functional group and the at least one second reactive functional group independently have one of the following structures:

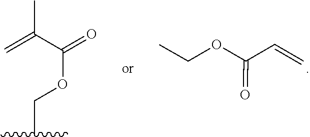

In some embodiments, the at least one first reactive functional group and the at least one second reactive functional group have one of the following structures:

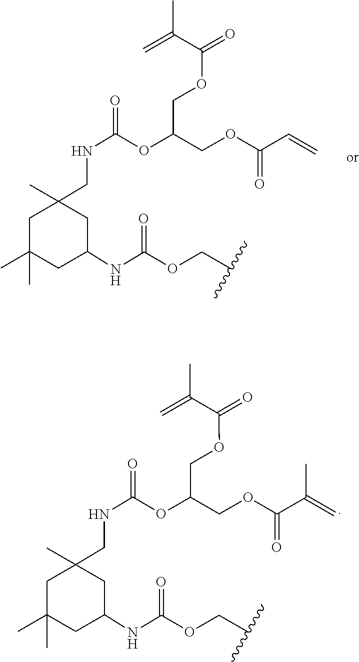

In some embodiments, the telechelic compound has one of the following structures:

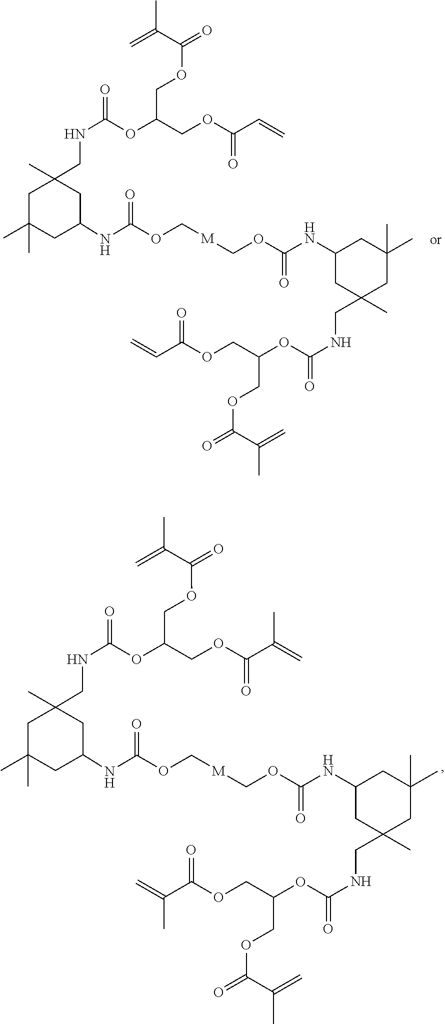

wherein: M is an oligomeric or polymeric chain of interconnected monomeric units selected from the group consisting of (poly)carbonate-(poly)urethane, (poly)ester-(poly)urethane, (poly)ether-(poly) urethane, (poly)thioether-(poly)urethane, hydrogenated (poly)butadiene, (poly)ester and (poly)urethane.

In some embodiments, the telechelic compound has a number average molecular weight greater than 5 kDa. In some embodiments, the telechelic compound has a number average molecular weight of 0.4 to 5 kDa. In some embodiments, the polymerizable resin composition comprises 1 to 75 wt %, based on the total weight of the composition, of the telechelic compound. In some embodiments, the polymerizable resin composition comprises 25 to 65 wt %, based on the total weight of the composition, of the telechelic compound. In some embodiments, the polymerizable resin composition comprises 30 to 60 wt %, based on the total weight of the composition, of the telechelic compound. In some embodiments, the polymerizable resin composition comprises 1 to 75 wt %, based on the total weight of the composition, of the reactive diluent. In some embodiments, the polymerizable resin composition comprises 5 to 50 wt %, based on the total weight of the composition, of the reactive diluent. In some embodiments, the polymerizable resin composition comprises 20 to 50 wt %, based on the total weight of the composition, of the reactive diluent. In some embodiments, the polymerizable resin composition comprises 1 to 1,000 ppm, based on the total weight of the composition, of the infrared absorbing marking additive. In some embodiments, the polymerizable resin composition comprises 1 to 400 ppm, based on the total weight of the composition, of the infrared absorbing marking additive. In some embodiments, the polymerizable resin composition comprises no greater than 100 ppm, based on the total weight of the composition, of the marking additive. In some embodiments, the polymerizable resin composition comprises 5 to 100 ppm, based on the total weight of the composition, of the marking additive. In some embodiments, the polymerizable resin composition further comprises an initiator. In some embodiments, the initiator comprises a photoinitiator. In some embodiments, the photoinitiator comprises diphenyl-(2,4,6-trimethylbenzoyl) phosphine oxide, ethyl-(2,4,6-trimethylbenzoyl) phenyl phosphinate or a combination thereof. In some embodiments, the initiator comprises a thermal initiator. In some embodiments, the thermal initiator comprises azobisisobutyronitrile, 2,2′-azodi (2-methylbutyronitrile) or a combination thereof. In some embodiments, the polymerizable resin composition comprises 0 to 20 wt %, based on the total weight of the composition of, the initiator. In some embodiments, the polymerizable resin composition comprises 0.01 to 10 wt % of the initiator. In some embodiments, the polymerizable resin composition further comprises a glass transition temperature modifier, a crosslinking modifier, a polymerization catalyst, a polymerization inhibitor, a light blocker, a plasticizer, a surface energy modifier, a filler, a biologically significant chemical, a solvent or combinations thereof. In some embodiments, the polymerizable resin composition is capable of being 3D printed at a printing temperature greater than 25° C. In some embodiments, the printing temperature is at least 30° C., 40° C., 50° C., 60° C., 80° C., or 100° C. In some embodiments, the polymerizable resin composition has a viscosity from 30 cP to 50,000 cP at a printing temperature. In some embodiments, the polymerizable resin composition is a liquid at a temperature from about 40° C. to about 100° C. In some embodiments, the polymerizable resin composition is a liquid at a temperature of above about 40° C. with a viscosity less than about 20 Pa·s. In some embodiments, the polymerizable resin composition is a liquid at a temperature of above about 40° C. with a viscosity less than about 1 Pa·s. In some embodiments, at least a portion of the polymerizable resin composition melts at a temperature between about 60° C. and about 100° C.

In another aspect, a polymeric material formed from such polymerizable resin composition is provided. In some embodiments, the polymeric material is characterized by one or more of: a stress relaxation of greater than or equal to 5% of the initial load; and a glass transition temperature of greater than or equal to 90° C. In some embodiments, the polymeric material is further characterized by one or more of: a tensile modulus greater than or equal to 100 MPa; a tensile strength at yield greater than or equal to 5 MPa; an elongation at yield greater than or equal to 4%; an elongation at break greater than or equal to 5%; a storage modulus greater than or equal to 300 MPa; and a stress relaxation greater than or equal to 0.01 MPa. In some embodiments, the polymeric material is characterized by a stress relaxation of 5% to 45% of the initial load. In some embodiments, the polymeric material is characterized by a stress relaxation of 20% to 45% of the initial load. In some embodiments, the polymeric material is characterized by a glass transition temperature of 90° C. to 150° C. In some embodiments, the polymeric material is characterized by a tensile modulus from 100 MPa to 2000 MPa. In some embodiments, the polymeric material is characterized by a tensile modulus from 800 MPa to 2000 MPa. In some embodiments, the polymeric material is characterized by a tensile strength at yield of 5 MPa to 85 MPa. In some embodiments, the polymeric material is characterized by a tensile strength at yield of 20 MPa to 55 MPa. In some embodiments, the polymeric material is characterized by a tensile strength at yield of 25 MPa to 55 MPa. In some embodiments, the polymeric material is characterized by an elongation at yield of 4% to 10%. In some embodiments, the polymeric material is characterized by an elongation at yield of 5% to 10%. In some embodiments, the polymeric material is characterized by an elongation at break of 5% to 250%. In some embodiments, the polymeric material is characterized by an elongation at break of 20% to 250%. In some embodiments, the polymeric material is characterized by a storage modulus of 300 MPa to 3000 MPa. In some embodiments, the polymeric material is characterized by a storage modulus of 750 MPa to 3000 MPa. In some embodiments, the polymeric material is characterized by a stress relaxation of 0.01 MPa to 15 MPa. In some embodiments, the polymeric material is characterized by a stress relaxation of 2 MPa to 15 MPa. In some embodiments, the polymeric material is characterized by: a stress relaxation of greater than or equal to 20% of the initial load; a glass transition temperature of greater than or equal to 90° C.; a tensile modulus from 800 MPa to 2000 MPa; and an elongation at break greater than or equal to 20%.

In another aspect, an orthodontic appliance comprising the polymeric material is provided. The orthodontic appliance comprises a marking area comprising a laser mark. In some embodiments, the orthodontic appliance is an aligner, an expender or a retainer. In some embodiments, the orthodontic appliance comprises a plurality of tooth receiving cavities configured to reposition teeth from a first configuration toward a second configuration. In some embodiments, the orthodontic appliance is one of a plurality of orthodontic aligners configured to reposition the teeth from an initial configuration toward a target configuration. In some embodiments, the orthodontic appliance is one of a plurality of aligners configured to reposition the teeth from an initial configuration toward a target configuration according to a treatment plan.

In yet another aspect, a method of forming an orthodontic appliance is provided. The method includes providing a polymerizable resin composition; curing the polymerizable resin composition to form a polymeric material; and fabricating the orthodontic appliance with the polymeric material. In some embodiments, curing the polymerizable resin composition comprises exposing the polymerizable resin composition to a light source. In some embodiments, the light source is an ultraviolet (UV) light source. In some embodiments, the method further comprises heating the polymerizable resin composition to a processing temperature. In some embodiments, the processing temperature is from about 50° C. to about 120° C. In some embodiments, the processing temperature is from about 90° C. to about 110° C., from about 100° C. to about 120° C., from about 105° C. to about 115° C., or from about 108° C. to about 110° C. In some embodiments, the further comprises heating the polymeric material at an elevated temperature. In some embodiments, the elevated temperature is from 40° C. to 150° C. In some embodiments, heating the polymeric material to the elevated temperature occurs after curing the polymerizable resin composition. In some embodiments, forming the orthodontic appliance comprises additive manufacturing. In some embodiments, forming the orthodontic appliance comprises printing the polymerizable resin composition with a 3D printer. In some embodiments, printing the polymerizable resin composition is performed using a high temperature lithography. In some embodiments, the orthodontic appliance is an aligner, an expender or a retainer.

In still another aspect, a method of preparing a medical device by an additive manufacturing process is provided. The method includes providing a polymerizable resin composition; heating the polymerizable resin composition to a processing temperature; exposing the polymerizable resin composition to radiation; polymerizing the polymerizable resin composition in a layer-by-layer manner based on a predefined design, thereby polymerizing the polymerizable resin composition to form a polymeric material; and fabricating the medical device with the polymeric material. In some embodiments, the processing temperature is from about 50° C. to about 120° C. In some embodiments, the additive manufacturing process is a 3D printing process. In some embodiments, the medical device is an orthodontic appliance.

In still another aspect, a method of marking an orthodontic appliance is provided. The method includes exposing a portion of the orthodontic appliance comprising a polymeric material formed from a polymerizable resin composition to a laser beam of an infrared laser for a first period of time. The polymeric material having an initial color dE*, and exposing causes a color change of the polymeric material in the exposed portion, thereby forming a mark in the exposed portion of the orthodontic appliance. In some embodiments, the infrared laser has an emission wavelength from 780 nm to 2000 nm. In some embodiments, the infrared laser has a laser fluence ranging from 0.1 mJ/mm² to 1 mJ/mm². In some embodiments, the infrared laser has a laser fluence of 0.3 mJ/mm². In some embodiments, the marking has an increase in dE* of greater than 8 compared to the initial dE*. In some embodiments, the mark comprises one or more of a numerical sequence, an alphanumeric character string, and a graphic symbol. In some embodiments, the mark comprises individual lines of a digital barcode. In some embodiments, the method further comprises moving the orthodontic appliance, the infrared laser, or both along a predetermined path as the orthodontic appliance is exposed to the laser beam, thereby forming the mark. In some embodiments, the method further comprises exposing the portion of the orthodontic appliance to the laser beam of the infrared laser for a second period of time, thereby increasing the degree of the color change of the polymeric material in the exposed portion. In some embodiments, the method further comprises forming the orthodontic appliance by additive manufacturing. In some embodiments, forming the orthodontic appliance comprises exposing the polymerizable resin composition to an ultraviolet (UV) light source; polymerizing the polymerizable resin composition to form the polymeric material; and fabricating the orthodontic appliance with the polymeric material. The IR absorbing marking additive does not absorb the UV radiation.

In still another aspect, a method of marking a polymerizable material is provided. The method includes exposing a portion of the polymeric material to a laser beam of an infrared laser for a first period of time. The polymeric material has an initial color dE*. The exposing causes a color change of the polymeric material in the exposed portion, thereby forming a mark in the exposed portion of the orthodontic appliance. In some embodiments, the infrared laser has an emission wavelength from 780 nm to 2000 nm. In some embodiments, the infrared laser has a laser fluence ranging from 0.1 mJ/mm² to 1 mJ/mm². In some embodiments, the infrared laser has a laser fluence of 0.3 mJ/mm². In some embodiments, the marking has an increase in dE* of greater than 8 compared to the initial dE*. In some embodiments, the mark comprises one or more of a numerical sequence, an alphanumeric character string, and a graphic symbol. In some embodiments, the mark comprises individual lines of a digital barcode. In some embodiments, the method further comprises moving the polymeric material, the infrared laser, or both along a predetermined path as the polymeric material is exposed to the laser beam, thereby forming the mark. In some embodiments, the method further comprises exposing the portion of the orthodontic appliance to the laser beam of the infrared laser for a second period of time, thereby increasing the degree of the color change of the polymeric material in the exposed portion.

In a further aspect, a method of repositioning a patient's teeth is provided. The method includes generating a treatment plan for a patient, the plan comprising a plurality of intermediate tooth arrangements for moving teeth along a treatment path from an initial arrangement toward a final arrangement; producing an orthodontic appliance; and moving on-track, with the orthodontic appliance, at least one of the patient's teeth toward an intermediate arrangement or a final tooth arrangement. In some embodiments, the method further comprises tracking progression of the patient's teeth along the treatment path after administration of the orthodontic appliance, the tracking comprising comparing a current arrangement of the patient's teeth to a planned arrangement of the teeth. In some embodiments, greater than 60% of the patient's teeth are on track with the treatment plan after 2 weeks of treatment. In some embodiments, the orthodontic appliance has a retained repositioning force to the at least one of the patient's teeth after 2 days that is at least 10%, at least 20%, at least 30%, at least 40%, at least 50%, at least 60%, or at least 70% of repositioning force initially provided to the at least one of the patient's teeth. In some embodiments, the method further comprises achieving on-track the movement of the at least one of the patient's teeth to the intermediate arrangement or the final tooth arrangement. In some embodiments, prior to moving on-track, with the orthodontic appliance, the at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a tooth repositioning appliance, in accordance with some embodiments.

FIG. 1B illustrates a tooth repositioning system, in accordance with some embodiments.

FIG. 1C illustrates a method of orthodontic treatment using a plurality of appliances, in accordance with some embodiments.

FIG. 2 is a partially schematic illustration of a system for additive manufacturing, in accordance with some embodiments.

FIG. 3 illustrates a method for designing an orthodontic appliance, in accordance with some embodiments.

FIG. 4 illustrates a method for digitally planning an orthodontic treatment, in accordance with some embodiments.

FIG. 5 illustrates a process for marking an orthodontic appliance, in accordance with some embodiments.

FIG. 6 illustrates a flowchart of a method for producing a marked orthodontic appliance, in accordance with some embodiments.

FIG. 7 shows generating and administering treatment, in accordance with some embodiments.

FIG. 8 shows a schematic configuration of a high temperature additive manufacturing device used for curing polymerizable compositions of the present disclosure by using a 3D printing process, in accordance with some embodiments.

FIG. 9 depicts color difference values produced by laser making compositions containing various IR absorbing marking additives after a single scan.

FIG. 10 depicts color difference values produced by laser marking compositions containing reactive diluents of varying conjugation lengths following one, two, or three scans.

### DETAILED DESCRIPTION

In the following description, certain specific details are set forth to provide a thorough understanding of various embodiments of the disclosure. However, one skilled in the art will understand that the disclosure may be practiced without these details.

Unless the context requires otherwise, throughout the present specification and claims, the word “comprise” and variations thereof, such as “comprises” and “comprising”, are to be construed in an open, inclusive sense, that is, as “including, but not limited to”.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Number ranges are to be understood as inclusive, i.e., including the indicated lower and upper limits. Furthermore, the term “about”, as used herein, and unless clearly indicated otherwise, generally refers to and encompasses plus or minus 10% of the indicated numerical value(s). For example, “about 10%” may indicate a range of 9% to 11%, and “about 1” may include the range 0.9-1.1.

The prefix “poly” in substance names such as “polyether” or “polyurethane” in the present disclosure indicates that the respective substance, in a formal sense, contains more than one of the functional groups that occur in its name per molecule.

As used herein, the term “monomer” refers to a molecule having a reactive functional group capable of undergoing a radical initiated polymerization reaction (e.g., alkenes or functionally substituted alkenes). Such polymerization reaction can be a photo-induced polymerization, e.g., via radical generation. In some embodiments, a monomer component is ethene, chloroethene, fluoroethene, chlorotrifluoroethene, tetrafluoroethene, propene, 2-methylpropene, styrene, propenenitrile, methyl methacrylate, phenyl ethylene, butyl acrylate, 1,6-hexandiol diacrylate, isobornyl methacrylate, homosalic methacrylate, ortho-phenylphenyl methacrylate, etc.

As used herein, the term “polymer” generally refers to a molecule composed of repeating structural units connected by covalent chemical bonds and characterized by a substantial number of repeating units (e.g., equal to or greater than 20 repeating units and often equal to or greater than 100 repeating units and often equal to or greater than 200 repeating units) and a molecular weight greater than or equal to 5,000 Daltons (Da) or 5 kDa, such as greater than or equal to 10 kDa, 15 kDa, 20 kDa, 30 kDa, 40 kDa, 50 kDa, or 100 kDa. Polymers are commonly the polymerization product of one or more monomer precursors. The term polymer includes homopolymers, i.e., polymers consisting essentially of a single repeating monomer species. The term polymer also includes copolymers which are formed when two or more different types (or species) of monomers are linked in the same polymer. Copolymers may comprise two or more different monomer species, and include random, block, alternating, segmented, grafted, tapered and other copolymers. The term “cross-linked polymers” generally refers to polymers having one or multiple links between at least two polymer chains, which can result from multivalent monomers forming cross-linking sites upon polymerization. In various embodiments, a polymer herein is a telechelic polymer capable of undergoing further polymerization reactions, e.g., with other polymerizable components present in a polymerizable resin composition.

As used herein, the term “oligomer” generally refers to a molecule composed of repeating structural units connected by covalent chemical bonds and characterized by a number of repeating units less than that of a polymer (e.g., equal to or less than 20 or less than 10 repeating units) and a lower molecular weight than polymers, e.g., less than 5,000 Da or less than 2,000 Da, and in various cases from about 0.4 kDa to about 5 kDa. In some cases, oligomers may be the polymerization product of one or more monomer precursors. In various embodiments, an oligomer herein is a telechelic oligomer capable of undergoing further polymerization reactions, e.g., with other polymerizable components present in a polymerizable resin composition.

As used herein, the terms “telechelic polymer” and “telechelic oligomer” generally refer to a polymer or oligomer the molecules of which are capable of entering, through polymerizable reactive functional groups, into further polymerization.

As used herein, the term “reactive diluent” generally refers to a substance which reduces the viscosity of another substance, such as a monomer or polymerizable resin. A reactive diluent may become part of another substance, such as a polymer obtained by a polymerization process. In some examples, a reactive diluent is a polymerizable monomer which, when mixed with a polymerizable resin, reduces the viscosity of the resultant formulation and is incorporated into the polymer that results from polymerization of the formulation.

Oligomer and polymer mixtures can be characterized and differentiated from other mixtures of oligomers and polymers by measurements of molecular weight and molecular weight distributions.

The molecular weight (M) is a number-average molecular weight (Mn), which is the average number of repeating units n times the molecular weight or molar mass (Mi) of the repeating unit. The number-average molecular weight (Mn) is the arithmetic mean, representing the total weight of the molecules present divided by the total number of molecules.

Photoinitiators described in the present disclosure can include those that can be activated with light and initiate polymerization of the polymerizable components of a resin or formulation. A “photoinitiator”, as used herein, may generally refer to a compound that can produce radical species and/or promote radical reactions upon exposure to radiation (e.g., UV or visible light).

The term “biocompatible,” as used herein, refers to a material that does not elicit an immunological rejection or detrimental effect, referred herein as an adverse immune response, when it is disposed within an in-vivo biological environment. For example, in embodiments a biological marker indicative of an immune response changes less than 10%, or less than 20%, or less than 25%, or less than 40%, or less than 50% from a baseline value when a human or animal is exposed to or in contact with the biocompatible material. Alternatively, immune response may be determined histologically, wherein localized immune response is assessed by visually assessing markers, including immune cells or markers that are involved in the immune response pathway, in and adjacent to the material. In an aspect, a biocompatible material or device does not observably change immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

“Bioinert” refers to a material that does not elicit an immune response from a human or animal when it is disposed within an in-vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individually or in any combination. Additionally, unless otherwise specified, all isotopic variants of compounds disclosed herein are intended to be encompassed by the disclosure. Specific names of compounds are intended to be exemplary, as it is known that one of ordinary skill in the art can name the same compounds differently.

It is noted that as used herein and in the appended claims, the singular forms “a”, “an”, and “the” include plural reference unless the context clearly dictates otherwise. Thus, for example, reference to “a monomer” includes a plurality of such monomers and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim.

As used herein, the term “group” may refer to a reactive functional group of a chemical compound. Groups of the present compounds refer to an atom or a collection of atoms that are a part of the compound. Groups of the present disclosure may be attached to other atoms of the compound via one or more covalent bonds. Groups may also be characterized with respect to their valence state. The present disclosure includes groups characterized as monovalent, divalent, trivalent, etc. valence states.

As used herein, the term “substituted” refers to a compound (e.g., an alkyl chain) wherein a hydrogen is replaced by another reactive functional group or atom, as described herein.

As used herein,

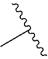

can be used to indicate a bond to the rest of the molecule. For example,

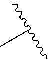

in, e.g.,

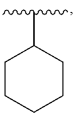 [SMILES: *C1CCCCC1]

can be used to indicate that the given moiety, the cyclohexyl moiety in this example, is attached to a molecule via the bond that is “capped” with the wavy line.

As used herein, the terms “aliphatic” and “aliphatic group” refer to a straight-chain or branched C₁-C₃₀ hydrocarbon chain that is completely saturated or that contains one or more units of unsaturation, or a monocyclic C₃-C₂₀ hydrocarbon or bicyclic C₈-C₂₀ hydrocarbon that is completely saturated or that contains one or more units of unsaturation, but which is not aromatic (also referred to herein as “cycloalkyl”), that has a single point of attachment to the rest of the molecule where in any individual ring in said bicyclic ring system has 3-7 members. For example, suitable aliphatic groups include, but are not limited to, linear or branched alkyl, alkenyl, alkynyl groups and hybrids thereof such as (cycloalkyl)alkyl, (cycloalkenyl) alkyl or (cycloalkyl) alkenyl.

As used herein, the terms “alkyl” and “alkyl group” refer to a straight-chain, branched and cyclic alkyl group, unless otherwise defined for a compound or genus of compounds. Alkyl groups include those having from 1 to 30 carbon atoms, unless otherwise defined. Thus, alkyl groups can include small alkyl groups having 1 to 3 carbon atoms, medium length alkyl groups having from 4-10 carbon atoms, as well as long alkyl groups having more than 10 carbon atoms, particularly those having 10-30 carbon atoms. The term cycloalkyl specifically refers to an alkyl group having a ring structure such as a ring structure comprising 3-30 carbon atoms, optionally 3-20 carbon atoms and optionally 3-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkyl groups can also carry alkyl groups. Cycloalkyl groups can include bicyclic and tricyclic alkyl groups. Alkyl groups are optionally substituted, as described herein. Substituted alkyl groups can include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Unless otherwise defined herein, substituted alkyl groups include fully halogenated or semihalogenated alkyl groups, such as alkyl groups having one or more hydrogens replaced with one or more fluorine atoms, chlorine atoms, bromine atoms and/or iodine atoms. Thus, substituted alkyl groups can include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alkyl portion of the groups is substituted as provided herein in connection with the description of alkyl groups. As used herein MeO-refers to CH₃O—. Moreover, a thioalkoxy group as used herein is an alkyl group that has been modified by linkage to a sulfur atom (instead of an oxygen) and can be represented by the formula R—S.

As used herein, the terms “alkenyl” and “alkenyl group” refer to a straight-chain, branched and cyclic alkenyl group. Alkenyl groups include those having 1, 2 or more double bonds and those in which two or more of the double bonds are conjugated double bonds. Unless otherwise defined herein, alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkenyl groups can also carry alkyl groups. Cycloalkenyl groups can include bicyclic and tricyclic alkenyl groups. Alkenyl groups are optionally substituted. Unless otherwise defined herein, substituted alkenyl groups include among others those that are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups can include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms.

As used herein, the terms “aryl” and “aryl group” refer to a group having one or more 5-, 6-, 7- or 8-membered aromatic rings, including heterocyclic aromatic rings. The term heteroaryl specifically refers to aryl groups having at least one 5-, 6-, 7- or 8-member heterocyclic aromatic ring. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein provided in a covalently bonded configuration in the compounds of the disclosure at any suitable point of attachment. In some embodiments, aryl groups contain between 5 and 30 carbon atoms. In some embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

As used herein, the terms “alkylene” and “alkylene group” refer to a divalent group “—CH₂—” derived from an alkyl group as defined herein. The disclosure includes compounds having one or more alkylene groups. Alkylene groups in some compounds function as attaching and/or spacer groups. Compounds of the disclosure may have substituted and/or unsubstituted C₁-C₂₀ alkylene, C₁-C₁₀ alkylene and C₁-C₆ alkylene groups.

As used herein, the terms “cycloalkylene” and “cycloalkylene group” refer to a divalent group derived from a cycloalkyl group as defined herein. The disclosure includes compounds having one or more cycloalkylene groups. Cycloalkyl groups in some compounds function as attaching and/or spacer groups. Compounds of the disclosure may have substituted and/or unsubstituted C₃-C₂₀ cycloalkylene, C₃-C₁₀ cycloalkylene and C₃-C₅ cycloalkylene groups.

As used herein, the terms “arylene” and “arylene group” refer to a divalent group derived from an aryl group as defined herein. The disclosure includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as attaching and/or spacer groups. Arylene groups in some compounds function as chromophore, fluorophore, aromatic antenna, dye and/or imaging groups. Compounds of the disclosure include substituted and/or unsubstituted C₅-C₃₀ arylene, C₅-C₂₀ arylene, C₅-C₁₀ arylene and C₅-C₆ arylene groups.

As used herein, the terms “heteroarylene” and “heteroarylene group” refer to a divalent group derived from a heteroaryl group as defined herein. The disclosure includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as attaching and/or spacer groups. Heteroarylene groups in some compounds function as chromophore, aromatic antenna, fluorophore, dye and/or imaging groups. Compounds of the disclosure include substituted and/or unsubstituted C₃-C₃₀ heteroarylene, C₃-C₂₀ heteroarylene, C₃-C₁₀ heteroarylene and C₃-C₆ heteroarylene groups.

As used herein, the terms “halo” and “halogen” can be used interchangeably and refer to a halogen group such as a fluoro (—F), chloro (—C₁), bromo (—Br) or iodo (—I).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and reactive functional groups, for example, provided as substituents.

The term “carbocyclic” refers to ring structures containing only carbon atoms in the ring. Carbon atoms of carbocyclic rings can be bonded to a wide range of other atoms and reactive functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy) n-alkoxy wherein n is an integer from 1 to 10, e.g., 1 to 4, and in some embodiments 1 to 3.

As used herein, the terms “heteroalkyl” and “heteroalkyl group” refer to an alkyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, from 1 to 12 non-hydrogen atoms, from 1 to 6 non-hydrogen atoms, or from 1 to 4 non-hydrogen atoms. Heteroalkyl groups may be straight or branched, and saturated or unsaturated. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

As used herein, the terms “heteroalkylene” and “heteroalkylene group” refer to a divalent heteroalkyl group derived from an heteroalkyl group as defined herein. Heteroalkylene groups in some compounds function as attaching and/or spacer groups. Compounds of the disclosure may have substituted and/or unsubstituted C₁-C₂₀ heteroalkylene, C₁-C₁₀ heteroalkylene and C₂-C₆ heteroalkylene groups.

The term “carbonyl”, as used herein, for example in the context of C₁₋₆ carbonyl substituents, generally refers to a carbon chain of given length (e.g., C₁₋₆), wherein each of the carbon atom of a given carbon chain can form the carbonyl bond, as long as it chemically feasible in terms of the valence state of that carbon atom. Thus, in some instance, the “C₁₋₆ carbonyl” substituent refers to a carbon chain of between 1 and 6 carbon atoms, and either the terminal carbon contains the carbonyl functionality, or an inner carbon contains the carbonyl functionality, in which case the substituent could be described as a ketone. The term “carboxy”, as used herein, for example in the context of C₁₋₆ carboxyl substituents, generally refers to a carbon chain of given length (e.g., C₁₋₆), wherein a terminal carbon contains the carboxy functionality, unless otherwise defined herein.

As to any of the groups described herein that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

Unless otherwise defined herein, optional substituents for any alkyl, alkenyl and aryl group include substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen or an alkyl group or an aryl group and more specifically where R is a methyl, ethyl, propyl, butyl, or phenyl group all of which groups are optionally substituted;
—COR, where R is a hydrogen or an alkyl group or an aryl group and more specifically where R is a methyl, ethyl, propyl, butyl, or phenyl group all of which groups are optionally substituted;
—CON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂, where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR, where R is an alkyl group or an aryl group and more specifically where R is a methyl, ethyl, propyl, butyl, or phenyl group, all of which are optionally substituted;
—OCOOR, where R is an alkyl group or an aryl group;
—SO₂N(R)₂, where each R, independently of each other R, is a hydrogen, or an alkyl group, or an aryl group all of which are optionally substituted and wherein R and R can form a ring that can contain one or more double bonds and can contain one or more additional carbon atoms; and
—OR, where R is H, an alkyl group, an aryl group, or an acyl group all of which are optionally substituted. In a particular example R can be an acyl yielding —OCOR″, wherein R″ is a hydrogen or an alkyl group or an aryl group and more specifically where R″ is methyl, ethyl, propyl, butyl, or phenyl groups all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, as further described herein, the compounds of this disclosure can include all stereochemical isomers (and racemic mixtures) arising from the substitution of these compounds.

Laser marking has long been employed for accurately marking a variety of materials, requiring minimal equipment and avoiding the need for special preparation, chemicals, or curing steps. Applying laser marks to 3D printed objects, such as orthodontic appliances, can facilitate their correct use in sequence and ensure specificity for individual users. Laser marking can be used to label an orthodontic appliance with information such as a numerical identifier, an alphanumeric sequence, or a design to indicate the sequence of use. These markings may also include patient readable details, such as a patient ID or treatment stage, among other information. In some embodiments, such markings are utilized during manufacturing to maintain the correct order of appliances or to group sets of appliances for shipping to the patient or treatment professional.

Laser marking of a 3D-printed object can be achieved by exposing the object to infrared (IR) radiation. The surface of the 3D-printed object absorbs the laser energy, which causes carbonization of the polymeric material and color change in the exposed region due to localized heating. This allows for direct “writing” of markings on the 3D-printed object. However, since most polymers have poor absorption of the laser energy in the IR region, using an IR laser for marking is often difficult or even impossible. In embodiments of the present disclosure, to increase the sensibility of the IR laser marking of 3D-printed objects, an IR absorbing marking additive is added to the UV curable resin composition to enhance the absorption of the cured composition to the laser energy in the IR region. Additionally, by using an IR absorbing marking additive in combination with an aliphatic, cycloaliphatic or aromatic reactive diluent in the resin composition, the IR laser marking performance can be further improved. This approach enables 3D-printed objects to be labeled with information, such as serial numbers and graphic signs, without the need for ink or other external marking materials.

### Polymerizable Resin Compositions

In one aspect, the present disclosure provides a polymerizable resin composition comprising a resin matrix and an IR-absorbing marking additive. The resin matrix includes a plurality of polymerizable components such as one or more species of telechelic oligomers and/or polymers as toughness modifiers and/or glass transition temperature modifies and one or more species of polymerizable monomers as reactive diluents.

### 1) Infrared Absorbing Marking Additives

The polymerizable resin composition of the present disclosure may comprise an IR absorbing marking additive configured to improve the laser absorbing properties and marking capabilities of the cured resin. This results in higher contrast markings on orthodontic appliances, without the need for ink or other external marking materials. The IR absorbing marking additive is selected to be compatible with the additive manufacturing process, meaning it has little or no absorption in the UV region of the absorption spectrum to avoid interfering with the UV curing of the polymerizable components in the resin matrix, while being an effective absorber of radiation in the IR region ranging from about 700 nm to 10.6 μm. For example, the IR absorbing marking additive suitable for the present disclosure may have an absorption ranging from 780 nm to 2000 nm. In some embodiments, the IR absorbing marking additive has an absorption maximum above 1000 nm, above 1050 nm, above 1100 nm, above 1125 nm, above 1140 nm, or above 1150 nm. Suitable IR absorbing marking additives that can be used in the present disclosure may include silicates (e.g., silicon oxide), metal silicates (e.g., pigment violet 15), organic fluorescent dyes (e.g., pigment violet 23), carbon-based calcined materials, metal oxides, metal carbonates, metal hydroxides, metal complexes, or zeolite nanoparticles. Examples of carbon-based calcined materials include, but not limited to, carbon black, graphene, carbon nanotubes, and combinations thereof. Examples of metal oxides include, but are not limited to, copper oxide, chromium oxide (e.g., pigment green 18), iron oxide (e.g., pigment yellow or pigment red 102), zinc oxide, tungsten oxide, molybdenum oxide, or combinations thereof. Metal complexes may include complexes of iron, copper, nickel, and cobalt with polydentate ligands of azo, azomethine, oxime, and isoindoline. In some embodiments, the metal complex is a metal-cyanine complex including copper phthalocyanine, zinc phthalocyanine, magnesium phthalocyanine, nickel phthalocyanine, or iron phthalocyanine. In some embodiments, the IR absorbing marking additive is selected from carbon black, pigment Violet 15, copper oxide, zinc oxide, and copper phthalocyanine.

The IR absorbing marking additive may be dispersed or dissolved in the resin matrix. In some embodiments, the IR absorbing marking additive includes a plurality of particles having a particle size less than 5 μm. For example, the marking particles may have a particle size less than 4 μm, less than 3 μm, less than 2 μm, or less than 1 μm. The amount of the IR absorbing marking additive in the polymerizable resin composition is controlled to ensure that the addition of the IR absorbing marking additive does not cause undesired coloration in the cured composition, allowing the 3D printed objects fabricated from such composition to remain clear. Additionally, the amount of the IR absorbing marking additive is optimized to maintain good printability of the polymerizable resin composition during the 3D printing process, while ensuring that the resulting 3D printed objects retain mechanical properties similar to those of 3D printed objects fabricated from polymerizable resin compositions without the IR absorbing marking additive. In some embodiments, the polymerizable resin composition may comprise 1 to 1,000 parts per million (ppm), for example, from 1 to 900 ppm, from 1 to 800 ppm, from 1 to 700 ppm, from 1 to 600 ppm, from 1 to 500 ppm, from 1 to 400 ppm, from 1 to 300 ppm, from 1 to 200 ppm, or from 1 to 100 ppm, based on the total weight of the composition, of the IR absorbing marking additive. In some embodiments, polymerizable resin composition may comprise 50 ppm, 100 ppm, 150 ppm, 200 ppm, 250 ppm, 300 ppm, 350 ppm, 400 ppm, or 500 ppm, based on the total weight of the composition, of the IR absorbing marking additive. In some embodiments, the polymerizable resin composition comprises no more than 100 ppm, no more than 90 ppm, no more than 80 ppm, no more than 70 ppm, no more than 60 ppm, no more than 50 ppm, no more than 40 ppm, no more than 30 ppm, or no more than 20 ppm, based on the total weight of the composition, of the IR absorbing marking additives. In some embodiments, the polymerizable resin composition comprises 100 ppm, based on the total weight of the composition, of a pigment such as Pigment Violet 15 or Oil Blue N. In some embodiments, the polymerizable resin composition comprises 100 ppm, based on the total weight of the composition, of a transition metal oxide such as copper oxide or zinc oxide. In some embodiments, the polymerizable resin composition comprises 100 ppm, based on the total weight of the composition, of a metal-cyanine complex such as copper (II) phthalocyanine. In some embodiments, the polymerizable resin composition comprises 5 ppm, based on the total weight of the composition, of a carbon-based calcined material such as carbon black.

### 2) Reactive Diluents

The polymerizable resin composition of the present disclosure may comprise one or more species of polymerizable monomers. Such polymerizable monomers can be used as reactive diluents to reduce the viscosity of the polymerizable resin composition. A reactive diluent can reduce the viscosity of the polymerizable resin composition by at least about 5% compared to a resin composition that does not comprise the reactive diluent. In some instances, a reactive diluent can reduce the viscosity of a polymerizable resin composition by at least about 5%, 10%, 20%, 30%, 40%, or 50%.

In various embodiments, a reactive diluent may comprise an acrylate or methacrylate moiety for incorporation into an oligomeric or polymeric backbone, coupled to a linear or cyclic (e.g., mono-, bi-, or tricyclic) side-chain moiety. Generally, any aliphatic, cycloaliphatic, or aromatic molecule with mono- or multi-functional polymerizable reactive functional groups can be used (also includes liquid crystalline monomers). In some embodiments, the reactive diluent comprises a mono-acrylate or methacrylate group. In some embodiments, the reactive diluent comprises di-acrylate or methacrylate groups. Specific reactive diluents suitable for use in the subject compositions include, but are not limited to, 3,3,5-trimethylcyclohexyl 2-(methacryloxy)benzoate (HSMA), benzyl salicylate methacrylate (BSMA), bisphenol A-glycidyl methacrylate (BisGMA), 2-hydroxyethyl methacrylate (HEMA), 2-hydroxybutyl methacrylate (HBMA), isobornyl methacrylate (IBOMA), cyclohexyl methacrylate, 2-ethylhexyl methacrylate (EHMA), 2-cyanoethyl methacrylate (CEMA), benzyl methacrylate (BMA), 2-phenoxyethyl methacrylate (PEMA), butyl methacrylate (BuMA), lauryl methacrylate (LMA), syringyl methacrylate (SMA), the corresponding acrylates, and combinations thereof.

In some embodiments, to further enhance the IR laser marketability of the cured resin, (meth)acrylate compounds with one or more pendant aromatic groups may be employed as the reactive diluents. The pendant aromatic groups have increased optical cross-section compared to aliphatic groups, which helps to enhance absorption efficiency of the cured resin in the IR region.

In some embodiments, the reactive diluent is a compound of Formula (III):

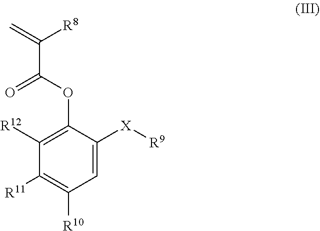

wherein:
X is O, S, NR¹³, or SiR¹⁴R¹⁵;
R⁸ is H, C₁₋₃ alkyl or halogen;
R⁹ is H, C₁₋₆ alkyl, C₁₋₆ heteroalkyl, C₁₋₆ carbonyl, C₁₋₆ carboxy, cyclo(C₃₋₈) alkyl, cyclo(C₃₋₈) heteroalkyl, aryl or heteroaryl;
R¹⁰ is H or aryl;
R¹¹ and R¹² are each independently H, C₁₋₆ alkyl, C₁₋₆ heteroalkyl, C₁₋₆ alkoxy, C₁₋₆ thioalkoxy, C₁₋₆ carbonyl, C₁₋₆ carboxy, or —Y—(CH₂)ₙ—R¹⁶; or R¹¹ and R¹² together form aryl or heteroaryl;
Y is O, S, NH orC(O)O;
n is an integer from 0 to 6;
R¹³, R¹⁴, and R¹⁵ are independently, H or C₁₋₆ alkyl; and
R¹⁶ is cyclo(C₃₋₈) alkyl, cyclo-(C₃₋₈) heteroalkyl, aryl or heteroaryl.

In some embodiments, R¹⁰ is H. In some embodiments, R¹⁰ is substituted or unsubstituted aryl.

In some embodiments, R¹¹ is H. In some embodiments, R¹¹ is substituted or unsubstituted C₁₋₆ alkyl, substituted or unsubstituted C₁₋₆ heteroalkyl, substituted or unsubstituted C₁₋₆ alkoxy, substituted or unsubstituted C₁₋₆ thioalkoxy, substituted or unsubstituted C₁₋₆ carbonyl, substituted or unsubstituted C₁₋₆ carboxy, or —Y—(CH₂)ₙ—R¹⁶. In some embodiments, R¹¹ is substituted or unsubstituted C₁₋₂ alkyl, substituted or unsubstituted C₁₋₂ heteroalkyl, substituted or unsubstituted C₁₋₂ alkoxy, substituted or unsubstituted C₁₋₂ thioalkoxy. In some embodiments, R¹¹ is substituted or unsubstituted C₃₋₆ alkyl, substituted or unsubstituted C₃₋₆ heteroalkyl, substituted or unsubstituted C₃₋₆ alkoxy, substituted or unsubstituted C₃₋₆ thioalkoxy. In some cases, R¹¹ is substituted or unsubstituted C₃₋₆ alkyl or substituted or unsubstituted C₃₋₆ alkoxy. In some embodiments, R¹¹ is substituted or unsubstituted C₄-6 alkyl or substituted or unsubstituted C₄-6 alkoxy.

In some embodiments, R¹² is H. In some embodiments, R¹² is substituted or unsubstituted C₁₋₆ alkyl, substituted or unsubstituted C₁₋₆ heteroalkyl, substituted or unsubstituted C₁₋₆ alkoxy, substituted or unsubstituted C₁₋₆ thioalkoxy, substituted or unsubstituted C₁₋₆ carbonyl, substituted or unsubstituted C₁₋₆ carboxy, or —Y—(CH₂)ₙ—R¹⁶. In some embodiments, R¹² is substituted or unsubstituted C₁₋₂ alkyl, substituted or unsubstituted C₁₋₂ heteroalkyl, substituted or unsubstituted C₁₋₂ alkoxy, substituted or unsubstituted C₁₋₂ thioalkoxy. In some embodiments, R¹² is substituted or unsubstituted C₃₋₆ alkyl, substituted or unsubstituted C₃₋₆ heteroalkyl, substituted or unsubstituted C₃₋₆ alkoxy, substituted or unsubstituted C₃₋₆ thioalkoxy. In some embodiments, R¹² is substituted or unsubstituted C₃₋₆ alkyl or substituted or unsubstituted C₃₋₆ alkoxy. In some embodiments, R¹² is substituted or unsubstituted C₄-6 alkyl or substituted or unsubstituted C₄-6 alkoxy.

In some embodiments, R⁸ is H or methyl. In some embodiments, X is O. In some embodiments, R¹⁰, R¹¹, and R¹² are each independently H. In some embodiments, R¹⁰ is H or aryl, R¹¹ and R¹² are each independently substituted or unsubstituted C₁₋₆ alkyl, substituted or unsubstituted C₁₋₆ heteroalkyl, substituted or unsubstituted C₁₋₆ alkoxy, substituted or unsubstituted C₁₋₆ thioalkoxy, substituted or unsubstituted C₁₋₆ carbonyl, substituted or unsubstituted C₁₋₆ carboxy, or —Y—(CH₂)ₙ—R¹⁶. In some embodiments, R¹⁰ is H or aryl, R¹¹ and R¹² are each independently H, substituted or unsubstituted C₁₋₆ alkyl or substituted or unsubstituted C₁₋₆ alkoxy. In some embodiments, at least one of R¹¹ and R¹² is substituted or unsubstituted C₁₋₆ alkoxy. In some embodiments, R¹¹ and R¹² together form a phenyl ring.

In some embodiments, R⁹ is substituted or unsubstituted cyclo(C₃₋₈) alkyl, substituted or unsubstituted cyclo(C₃₋₈) heteroalkyl, substituted or unsubstituted aryl, or substituted or unsubstituted heteroaryl. In some embodiments, R⁹ is unsubstituted cyclo(C₃₋₈) alkyl, unsubstituted cyclo(C₃₋₈) heteroalkyl, unsubstituted aryl, or unsubstituted heteroaryl. In some embodiments, R⁹ is substituted or unsubstituted cyclo(C₃₋₈) alkyl or substituted or unsubstituted aryl. In some embodiments, R⁹ is unsubstituted cyclo(C₃₋₈) alkyl or unsubstituted aryl. In some embodiments, R⁹ is substituted or unsubstituted C₁₋₆ alkyl, substituted or unsubstituted C₁₋₆ heteroalkyl, substituted or unsubstituted C₁₋₆ carbonyl, substituted or unsubstituted C₁₋₆ carboxy. In some embodiments, R⁹ is unsubstituted C₁₋₆ alkyl, unsubstituted C₁₋₆ heteroalkyl, unsubstituted C₁₋₆ carbonyl, or unsubstituted C₁₋₆ carboxy. In some embodiments, R⁹ is substituted or unsubstituted C₁₋₆ alkyl or substituted or unsubstituted C₁₋₆ heteroalkyl. In some embodiments, R⁹ is unsubstituted C₁₋₃ alkyl or unsubstituted C₁₋₃ heteroalkyl. In some embodiments, R⁹ is unsubstituted C₄-6 alkyl or unsubstituted C₄-6 heteroalkyl. In some embodiments, R⁹ is substituted or unsubstituted C₁₋₂ alkyl. In some embodiments, R⁹ is methyl or ethyl.

In some embodiments, the reactive diluent has one of the following structures:

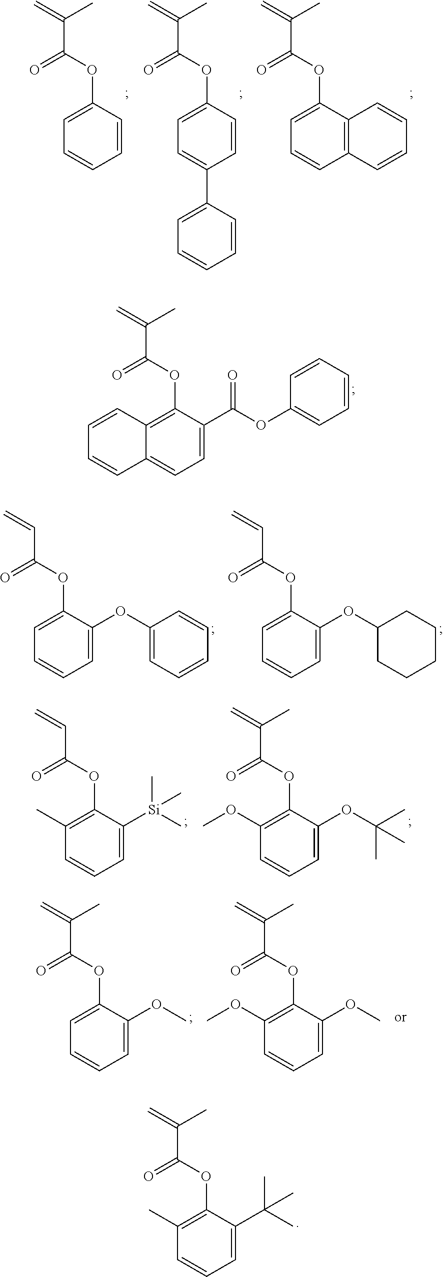

In some embodiments, the reactive diluent of the present disclosure can have a low vapor pressure at an elevated temperature and a high boiling point. Such low vapor pressure can be particularly advantageous for use of such monomer in polymerizable (e.g., photopolymerizable) resin compositions and additive manufacturing where elevated temperatures (e.g., 60° C., 80° C., 90° C., or higher) may be used. In various instances, the reactive diluent can have a vapor pressure of at most about 12 Pa at 60° C. In various instances, the reactive diluent can have a vapor pressure of at most about 2 Pa to 10 Pa at 60° C. In various instances, the reactive diluent can have a vapor pressure of at most about 2 Pa to 5 Pa at 60° C. Thus, in some embodiments, the reactive diluent of the present disclosure can have a low mass loss at an elevated temperature. As used herein, a mass loss of a compound at a certain temperature (e.g., 90° C.) for a certain time period (e.g., 2 hours) can be used as a measure for volatility of such compounds. Herein, “substantially no volatility” can refer to a mass loss of less than 1 wt % at the respective temperature, e.g., at 90° C. for 2 hours. In various instances, the reactive diluent of the present disclosure can have a mass loss of less than 1 wt % at the respective temperature at 90° C. after heating at that temperature for 2 hours. In some embodiments, the reactive diluent can have a mass loss of less than about 0.5% after heating at 90° C. for 2 h. In some embodiments, the reactive diluent can have a mass loss of about 0.1% to about 0.45% after heating at 90° C. for 2 h. In some embodiments, the reactive diluent can have a mass loss of about 0.05% to about 0.25% after heating at 90° C. for 2 h.

In some embodiments, the reactive diluent of the present disclosure can have a molecular weight of at least about 150 Da, 200 Da, 250 Da, 300 Da, 350 Da, 400 Da, or at least about 450 Da. In some instances, the reactive diluent has a molecular weight of less than about 750 Da.

In some embodiments, the reactive diluent of the present disclosure can have a melting point of at least about 20° C., 30° C., 40° C., 50° C., or higher. The melting point of the reactive diluent is lower than the processing temperatures employed in current high temperature lithography-based photopolymerization processes, which are typically in the range of 50 to 120° C., such as 90 to 120° C. Therefore, the reactive diluents can have a melting point less than 120° C., less than 90° C., less than 70° C., or even less than 50° C. or less than 30° C., which provides for low viscosities of the melts and, consequently, for more pronounced viscosity-lowering effects when they are used as reactive diluents for resin compositions to be cured by means of high temperature lithography-based polymerization. In some cases, they are liquid at room temperature, which, in addition to the above advantages, facilitates their handling.

In some embodiments, the polymerizable resin composition comprises 1 to 75 wt %, 1 to 70 wt %, 1 to 60 wt %, 1 to 50 wt %, 1 to 40 wt %, 1 to 30 wt %, 1 to 25 wt %, 1 to 20 wt %, 10 to 70 wt %, 10 to 70 wt %, 10 to 60 wt %, 10 to 50 wt %, 10 to 40 wt %, 10 to 30 wt %, 10 to 25 wt %, 20 to 70 wt %, 20 to 60 wt %, 20 to 50 wt %, 20 to 40 wt %, 20 to 35 wt %, or 20 to 30 wt %, based on the total weight of the composition, of the reactive diluent. In certain embodiments, the polymerizable resin composition may comprise 5 to 50 wt % or 20 to 50 wt %, based on the total weight of the composition, of the reactive diluent. In certain embodiments, the polymerizable resin composition may comprise 20 to 50 wt %, based on the total weight of the composition, of the reactive diluent.

### 3) Toughness Modifiers

The polymerizable resin composition may comprise one or more species of telechelic compounds. Such a telechelic compound can be a telechelic oligomer or a telechelic polymer. In some embodiments, the telechelic compound comprises an oligomeric or polymeric chain of interconnected monomeric units having at least one terminal reactive functional group coupled at each end. In some embodiments, the linear oligomeric or polymeric chain is selected from (poly)carbonate-(poly)urethane, (poly)ester-(poly)urethane, (poly)ether-(poly)urethane, (poly)thioether-(poly)urethane, hydrogenated (poly)butadiene, (poly)ester or (poly)urethane, and the terminal reactive functional group is selected from an acrylate, a methacrylate, a vinyl acrylate, a vinyl methacrylate, an allyl ether, a silene, an alkyne, an alkene, a vinyl ether, a maleimide, a fumarate, a maleate, an itaconate, an epoxide, and a styrenyl.

In some embodiments, the first terminal end, the second terminal end, or both, comprises a reactive functional group having one of the following structures:

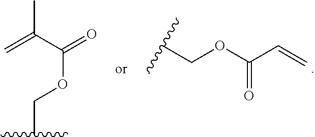

In some embodiments, the first terminal end, the second terminal end, or both, has a reactive functional group having one of the following structures:

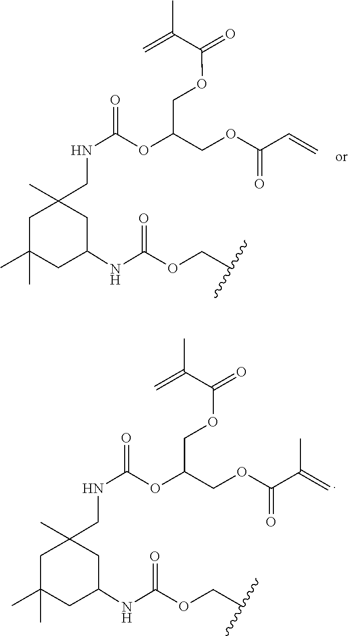

In some embodiments, the telechelic compound has one of the following structures:

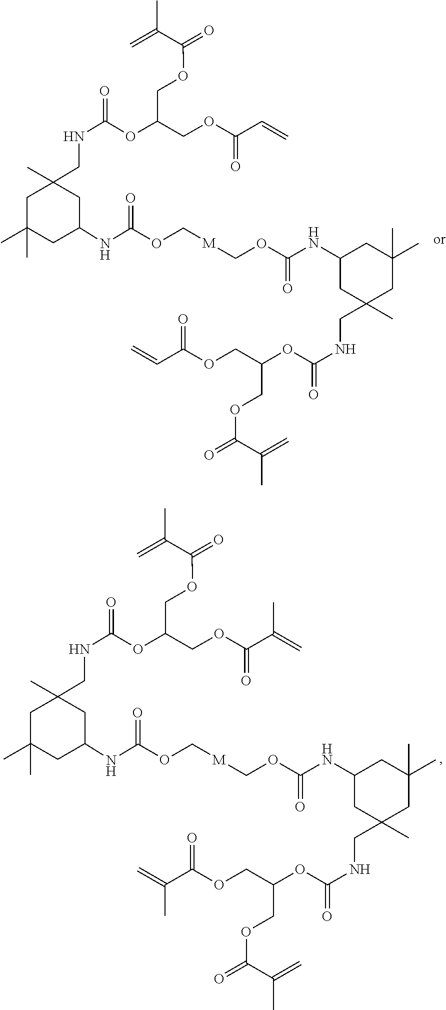

wherein M is an oligomeric or polymeric chain of (poly)carbonate-(poly)urethane, (poly)ester-(poly) urethane, (poly)ether-(poly)urethane, (poly)thioether-(poly)urethane, hydrogenated (poly)butadiene, (poly)ester or (poly)urethane.

In some embodiments, the telechelic compound is a telechelic polymer having a number average molecular weight greater than 5 kDa. Such telechelic polymer can be used as a toughness modifier for a polymeric material to be generated using a polymerizable resin composition herein. The toughness modifier provides for high elongation at break and toughness via strengthening effects.

The toughness modifier of the subject compositions may have a low glass transition temperature (T_{g}), such as a T_{g} less than 0° C., which can add to tough behavior if used above its glass transition temperature. In some examples, the T_{g} of the toughness modifier may be less than 25° C., such as less than 15° C., less than 10° C., less than 5° C., less than 0° C., less than −5° C., or less than −10° C. The T_{g} of a polymer or composition described herein may be assessed using dynamic mechanical analysis (DMA) and is provided herein as the tan & peak.

The toughness modifier can have a number average molecular weight greater than 5 kDa, 6 kDa, 7 kDa, 8 kDa, 9 kDa, 10 kDa, 11 kDa, 12 kDa, 13 kDa, 14 kDa, 15 kDa, 16 kDa, 17 kDa, 18 kDa, 19 kDa, 20 kDa, 21 kDa, 22 kDa, 23 kDa, 24 kDa, or greater than 25 kDa. In some embodiments, the toughness modifier has a number average molecular weight ranging from 7-15 kDa. In certain embodiments, the toughness modifier has a number average molecular weight ranging from 8-10 kDa, 8-15 kDa, 9-10 kDa, 9-15 kDa, 10-20 kDa, 11-15 kDa, 12-15 kDa, 15-20 kDa, 13-15 kDa, or 17-20 kDa.

The polymerizable resin composition can comprise 1 to 75 wt %, 1 to 70 wt %, 1 to 60 wt %, 1 to 50 wt %, 1 to 40 wt %, 1 to 30 wt %, 1 to 25 wt %, 10 to 75 wt %, 10 to 70 wt %, 10 to 60 wt %, 10 to 50 wt %, 10 to 40 wt %, 10 to 30 wt %, 10 to 25 wt %, 20 to 75 wt %, 20 to 70 wt %, 20 to 60 wt %, 20 to 50 wt %, 20 to 40 wt %, 20 to 35 wt %, 20 to 30 wt %, 25 to 75 wt %, 25 to 70 wt %, 25 to 60 wt %, 25 to 50 wt %, 25 to 45 wt %, 25 to 40 wt %, or 25 to 35 wt %, based on the total weight of the composition, of the toughness modifier. In certain embodiments, the polymerizable resin composition may comprise 25 to 35 wt %, based on the total weight of the composition, of the toughness modifier. In certain embodiments, the polymerizable resin composition may comprise 20 to 40 wt %, based on the total weight of the composition, of the toughness modifier.

In some embodiments, the toughness modifier is polyether modified (poly)carbonate-(poly) urethane dimethacrylate. In some embodiments, the toughness modifier comprises a compound according to Formula (II), (III), (IV), or (V):

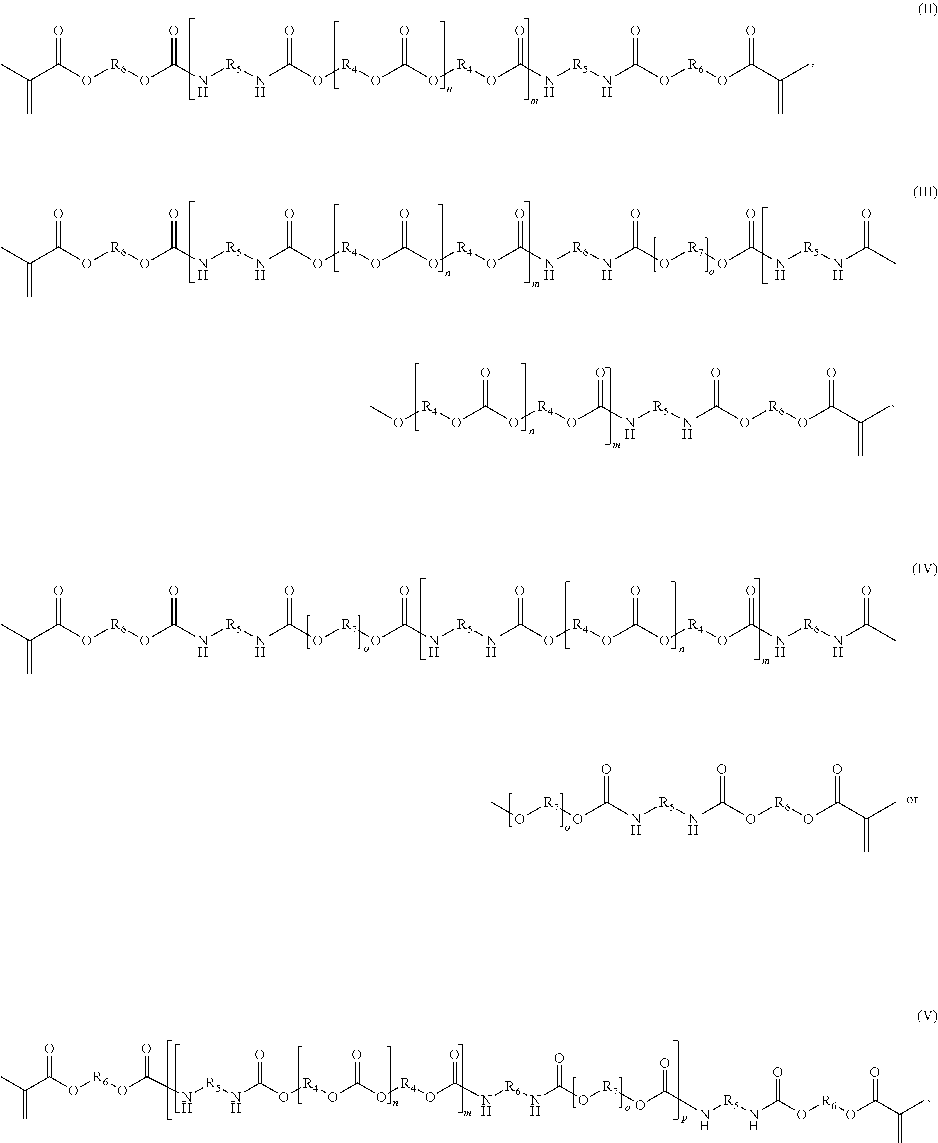

wherein:
each R₄ and each R₅ independently represent a divalent, linear, branched or cyclic C₅—C₁₅ alkyl radical,
each R₆ independently represents a divalent, linear or branched C₂-C₄ alkyl radical,
each R₇ independently represents a divalent, linear or branched C₂-C₆ alkyl radical,
each n is independently an integer from 1 to 10,
each m is independently an integer from 1 to 20,
each o is independently an integer from 5 to 50, and
p is an integer from 1 to 40,
with the proviso that R₄, R₅, R₆, R₇, n, m, o and p are selected so as to result in a number average molecular weight of the (poly)carbonate-(poly)urethane dimethacrylate greater than 5 kD.

In some embodiments, R₄ is a divalent radical originating from a diol selected from the group consisting of 2,2-dimethyl-1,3-propanediol (DMP), 1,6-hexanediol, 1,4-cyclohexanedimethanol (CHDM), and mixtures thereof. In certain embodiments, R₄ is the alcoholic moiety of a polycarbonate.

In some embodiments, R₅ is a divalent radical originating from a diisocyanate selected from the group consisting of isophorone diisocyanate (IPDI), hexamethylene diisocyanate (HDI), trimethylhexamethylene diisocyanate (2,2,4- and 2,4,4-mixture, TMDI), dicyclohexylmethane 4,4′-diisocyanate (HMDI), 1,3-bis(isocyanatomethyl) cyclohexane, and mixtures thereof.

In some embodiments, R₆ is a divalent radical originating from a diol independently selected from the group consisting of 1,2-ethanediol, 1,3-propanediol, 1,2-propanediol, 1,4-butanediol, and mixtures thereof. In certain embodiments, R₆ is a divalent radical originating from 1,2-ethanediol.

In some embodiments, R₇ is a divalent radical originating from a diol selected from the group consisting of C₂-C₆ alkane diols and mixtures thereof. In certain embodiments, R₇ is a divalent radical originating from 1,4-butanediol.

Specific toughness modifiers suitable for use in the subject compositions are described herein below, including compounds of Formula (II), (III), (IV) or (V). In some embodiments, the toughness modifier is selected from UA5216 (Miwon), TNM1, TNM2, TNM3, TNM4, TNM5, and TNM6. The TNM1, TNM2, TNM3, TNM4, TNM5, and TNM6 have the following structures, respectively:

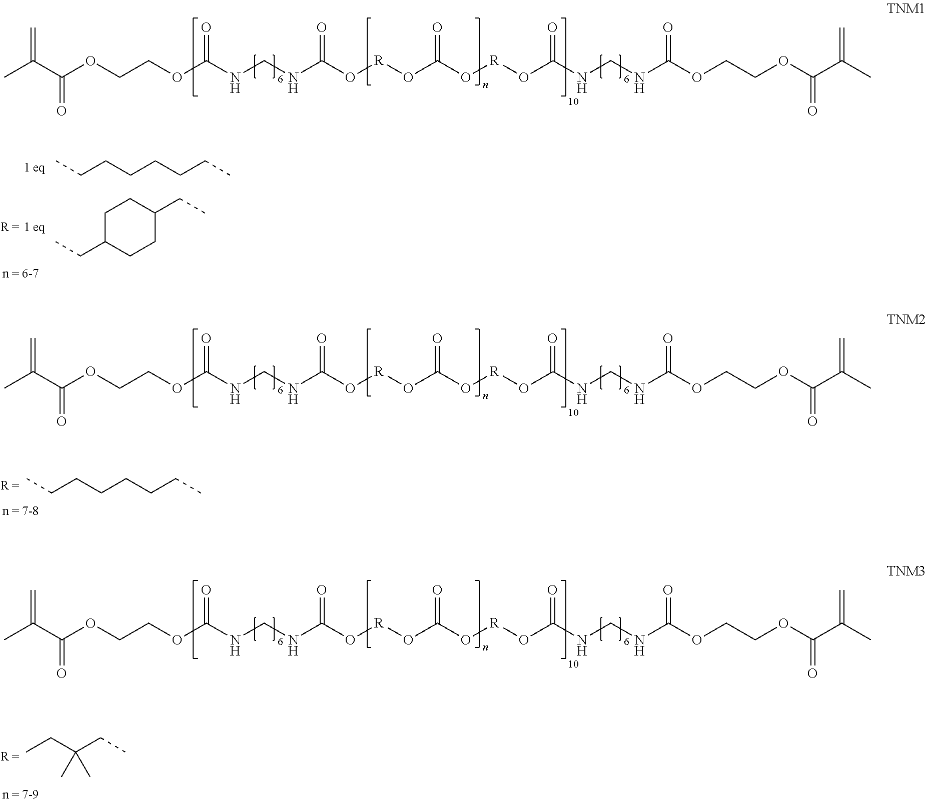

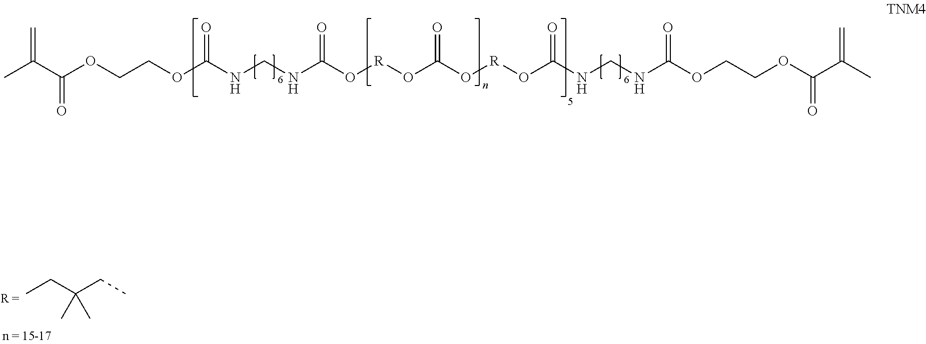

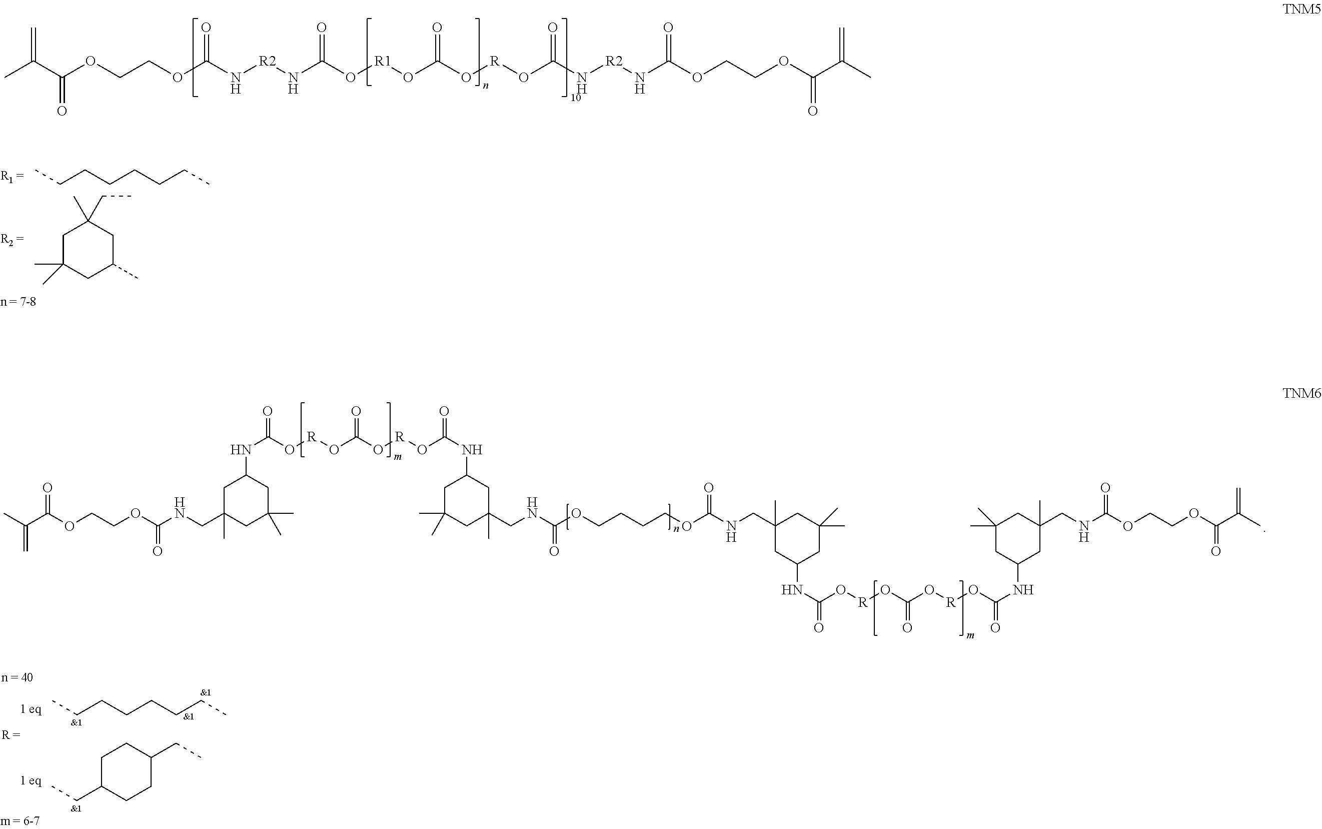

### 4) Glass Transition Temperature Modifiers

In some embodiments, a polymerizable resin composition of the present disclosure may further comprises a glass transition temperature (T_{g}) modifier (also referred to herein as a T_{g} modifier). The T_{g} modifier can have a high glass transition temperature, which leads to a high heat deflection temperature, which can be necessary to use a material at elevated temperatures. The toughness modifier, the reactive diluent and the T_{g} modifier are typically miscible and compatible in the methods described herein. When used in the subject compositions, the T_{g} modifier may provide for high T_{g} and strength values, sometimes at the expense of elongation at break. The toughness modifier may provide for high elongation at break and toughness via strengthening effects, and the reactive diluent may improve the processability of the formulations, particularly of those comprising high amounts of toughness modifiers, while maintaining high values for strength and T_{g}. The T_{g} modifier typically has a higher T_{g} than the toughness modifier.

In certain embodiments, the polymerizable resin composition comprises 0 to 80 wt %, 0 to 75 wt %, 0 to 70 wt %, 0 to 65 wt %, 0 to 60 wt %, 0 to 55 wt %, 0 to 50 wt %, 1 to 50 wt %, 2 to 50 wt %, 3 to 50 wt %, 4 to 50 wt %, 5 to 50 wt %, 10 to 50 wt %, 15 to 50 wt %, 20 to 50 wt %, 25 to 50 wt %, 30 to 50 wt %, 35 to 50 wt %, 0 to 40 wt %, 1 to 40 wt %, 2 to 40 wt %, 3 to 40 wt %, 4 to 40 wt %, 5 to 40 wt %, 10 to 40 wt %, 15 to 40 wt %, or 20 to 40 wt % of a T_{g} modifier. In certain embodiments, the polymerizable resin composition comprises 0-50 wt % of a glass transition modifier.

The T_{g} modifier can be a telechelic oligomer having a number average molecular weight ranging from 0.4 to 5 kDa. In certain embodiments, the number average molecular weight of the T_{g} modifier is from 0.4 to 5 kDa, 0.5 to 5 kDa, from 0.6 to 5 kDa, from 0.7 to 5 kDa, from 0.8 to 5 kDa, from 0.9 to 5 kDa, from 1.0 to 5 kDa, from 0.4 to 4 kDa, from 0.5 to 4 kDa, from 0.6 to 4 kDa, from 0.7 to 4 kDa, from 0.8 to 4 kDa, from 0.9 to 4 kDa, from 1 to 4 kDa, from 0.4 to 3 kDa, from 0.5 to 3 kDa, from 0.6 to 3 kDa, from 0.7 to 3 kDa, from 0.8 to 3 kDa, from 0.9 to 3 kDa, or from 1 to 3 kDa.

In certain embodiments, the T_{g} modifier may comprise a urethane group. In certain embodiments, the T_{g} modifier comprises at least one methacrylate group. Specific T_{g} modifiers suitable for use in the subject compositions are described herein below, including compounds of Formula (I). In some embodiments, the T_{g} modifier is a polyester dimethacrylate oligomer or a polyurethane dimethacrylate oligomer. In some embodiments, the T_{g} is polyether modified polyurethane dimethacrylate. In certain embodiments, the T_{g} modifier is selected from H1188 (bis((2-((methacryloyloxy) methyl) octahydro-1H-4,7-methanoinden-5-yl)methyl) cyclohexane-1,4-dicarboxylate), TGM1, TGM2, TGM3, TGM4, and a compound of Formula (I). In certain embodiments, the T_{g} modifier is a derivative of H1188, TGM1, TGM2, TGM3, TGM4, or a derivative of the compound of formula (I). In certain embodiments, the T_{g} modifier is a blend of modifiers comprising H1188, TGM1, TGM2, TGM3, TGM4, or a compound of Formula (I).

In some embodiments, the T_{g} modifier is H1188:

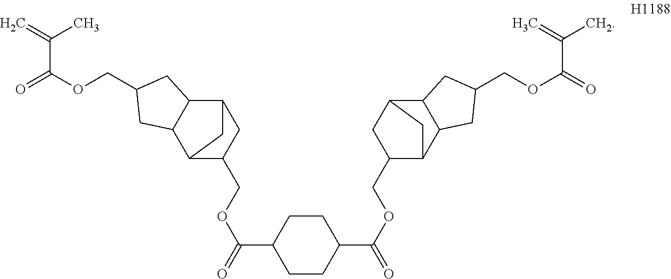

In some embodiments, the T_{g} modifier is TGM1:

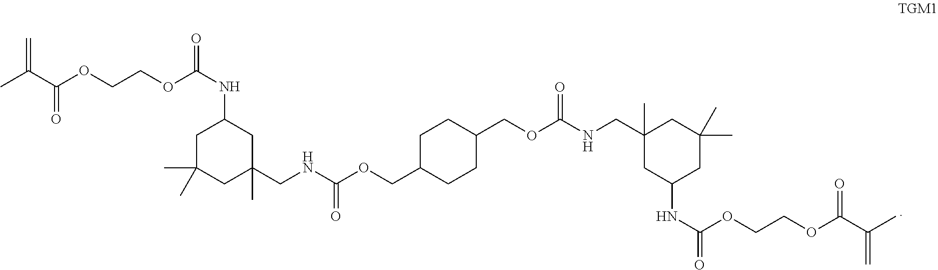 [SMILES: C=C(C)C(=O)OCCOC(=O)NC1CC(C)(C)CC(C)(CNC(=O)OCC2CCC(COC(=O)NCC3(C)CC(NC(=O)OCCOC(=O)C(=C)C)CC(C)(C)C3)CC2)C1]

In some embodiments, the T_{g} modifier is TGM2:

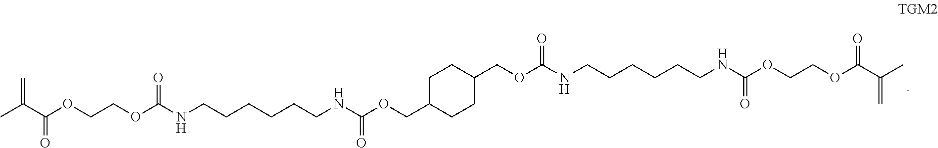 [SMILES: C=C(C)C(=O)OCCOC(=O)NCCCCCCNC(=O)OCC1CCC(COC(=O)NCCCCCCNC(=O)OCCOC(=O)C(=C)C)CC1]

In some embodiments, the T_{g} modifier is TGM3:

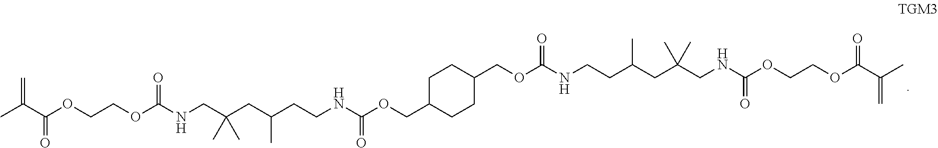 [SMILES: C=C(C)C(=O)OCCOC(=O)NCC(C)(C)CC(C)CCNC(=O)OCC1CCC(COC(=O)NCCC(C)CC(C)(C)CNC(=O)OCCOC(=O)C(=C)C)CC1]

In some embodiments, the T_{g} modifier is TGM4:

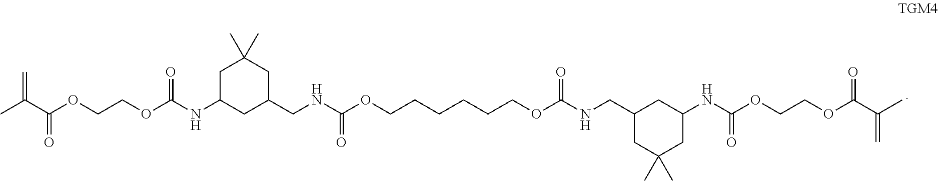 [SMILES: C=C(C)C(=O)OCCOC(=O)NC1CC(CNC(=O)OCCCCCCOC(=O)NCC2CC(NC(=O)OCCOC(=O)C(=C)C)CC(C)(C)C2)CC(C)(C)C1]

In some embodiments, the T_{g} modifier is a compound of Formula (I):

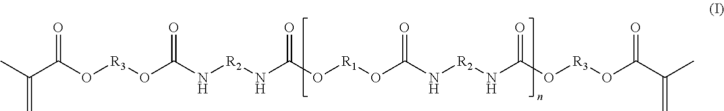

wherein:
each R₁ and each R₂ independently represent a divalent, linear, branched or cyclic C₅—C₁₅ alkyl radical, with the proviso that at least one of R¹ and R₂ is or comprises a C₅—C₆ cycloalkyl structure;
each R₃ independently represents a divalent, linear or branched C₂-C₄ alkyl radical; and
n is an integer from 1 to 5;
with the proviso that R₁, R₂, R₃ and n are selected so as to result in a number average molecular weight of the oligomeric dimethacrylate from 0.4 to 5 kDa.

In some embodiments, the T_{g} modifier comprises a plurality of aliphatic rings. In certain embodiments, the T_{g} modifier comprises a plurality of aliphatic rings. In some aspects, the aliphatic rings are hydrocarbon rings. In some embodiments, the aliphatic rings are saturated. In some embodiments, the plurality of aliphatic rings comprise cyclobutane, cyclopentane, cyclohexane, cycloheptane, cyclooctane, cyclononane, cyclodecane, or any combination thereof. In some embodiments, the plurality of aliphatic rings include bridged ring structures. In some embodiments, the plurality of aliphatic rings includes fused ring structures. In certain embodiments, the middle portion of the T_{g} modifier comprises a cyclohexane-1,4-dicarboxylic acid, a cyclohexanedimethanol, a cyclohexane-1,4-diylbis(methylene) dicarbamate, or a combination thereof. In certain embodiments, the center of the T_{g} modifier structure comprises a cyclohexane-1,4-diylbis(methylene) dicarbamate (e.g., TGM1, TGM2, and TGM3).

In some embodiments, the T_{g} modifier comprises a methacrylate. In some embodiments, the T_{g} modifier comprises at least two methacrylates. In certain embodiments, the T_{g} modifier has terminal portions comprising methacrylates. In some embodiments, the T_{g} modifier has a structure that terminates at each end with a methacrylate. In some embodiments, the T_{g} modifier is a bis(2-methacrylate) (e.g., TGM1, TGM2, TGM3, TGM4, and H1188).

In some embodiments, the T_{g} modifier comprises a blend of components, selected from TGM1, TGM2, TGM3, TGM4, H1188, a compound of Formula (I), D3MA (1,10-decanediol dimethacrylate), D4MA (1,12-dodecanediol dimethacrylate), LPU624, a derivative thereof, or a combination thereof. In some embodiments, the T_{g} modifier comprises Bomar XR-741 MS.

### 5) Initiators

In various embodiments, the polymerizable resin composition disclosed herein is a photopolymerizable composition. In some embodiments, the polymerizable resin composition comprises an initiator that is a photoinitiator. Such photoinitiator, when activated with light of an appropriate wavelength (e.g., UV/VIS) can initiate a polymerization reaction (e.g., during photo-curing) between the monomers, toughness modifiers, and other potentially polymerizable components that may be present in the photopolymerizable matrix, to form a polymeric material as further described herein. Generally, photoinitiators described in the present disclosure can include those that can be activated with light and initiate polymerization of the polymerizable components of the formulation. A “photoinitiator”, as used herein, may generally refer to a compound that can produce radical species and/or promote radical reactions upon exposure to radiation (e.g., UV or visible light).

In some embodiments, the photoinitiator is a radical photoinitiator and/or a cationic initiator. In some embodiments, the photoinitiator is a Type I photoinitiator which undergoes a unimolecular bond cleavage to generate free radicals. In an additional embodiment, the photoinitiator is a Type II photoinitiator which undergoes a bimolecular reaction to generate free radicals. Common Type I photoinitiators include, but are not limited to, benzoin ethers, benzil ketals, α-dialkoxy-acetophenones, α-hydroxy-alkyl phenones, and acyl-phosphine oxides. Common Type II photoinitiators include benzophenones/amines and thioxanthones/amines. Cationic initiators include aryldiazonium, diaryliodonium, and triarylsulfonium salts. In preferred embodiments, the photoinitiator comprises phenylbis(2,4,6-trimethylbenzoyl) phosphine oxide (BAPO), diphenyl-(2,4,6-trimethylbenzoyl) phosphine oxide (TPO), ethyl-(2,4,6-trimethylbenzoyl)phenylphosphinate (TPO-L), or a combination thereof.

In some embodiments, the photoinitiator initiates photopolymerization using light energy. In certain embodiments, the photoinitiator initiates photopolymerization with exposure to light energy from 800 nm to 250 nm, from 800 nm to 350 nm, from 800 nm to 450 nm, from 800 nm to 550 nm, from 800 nm to 650 nm, from 600 nm to 250 nm, from 600 nm to 350 nm, from 600 nm to 450 nm, or from 400 nm to 250 nm. In some embodiments, the photoinitiator initiates photopolymerization following absorption of two photons, which can use longer wavelengths of light to initiate the photopolymerization.

In some embodiments, the polymerizable resin composition comprises more than one initiator (e.g., 2, 3, 4, 5, or more than 5 initiators). In some embodiments, the polymerizable resin composition comprises an initiator that is a thermal initiator. In certain embodiments, the thermal initiator comprises an organic peroxide. In some embodiments, the thermal initiator comprises an azo compound, an inorganic peroxide, an organic peroxide, or any combination thereof. In some embodiments, the thermal initiator is selected from the group consisting of tert-amyl peroxybenzoate, 4,4-azobis(4-cyanovaleric acid), 1,1′-azobis(cyclohexanecarbonitrile), 2,2′-azobisisobutyronitrile (AIBN), benzoyl peroxide, 2,2-bis(tert-butylperoxy) butane, 1,1-bis(tert-butylperoxy) cyclohexane, 2,5-bis(tert-butylperoxy)-2,5-dimethylhexane, 2,5-bis(tert-butylperoxy)-2,5-dimethyl-3-hexyne, 1,1-bis(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi (2-methylbutyronitrile), or a combination thereof.

In some embodiments, the polymerizable resin composition comprises 0.01-10 wt %, 0.02-5 wt %, 0.05-4 wt %, 0.1-3 wt %, 0.1-2 wt %, or 0.1-1 wt %, based on the total weight of the composition, of the initiator. In preferred embodiments, the polymerizable resin composition comprises 0.1-2 wt % of the initiator. In some embodiments, the polymerizable resin composition comprises 0.01-10 wt %, 0.02-5 wt %, 0.05-4 wt %, 0.1-3 wt %, 0.1-2 wt %, or 0.1-1 wt % of the photoinitiator. In preferred embodiments, the polymerizable resin composition comprises 0.1-2 wt % of the photoinitiator. In some embodiments, the polymerizable resin composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt % of the thermal initiator. In preferred embodiments, the polymerizable resin composition comprises from 0 to 0.5 wt % of the thermal initiator.

### 6) Additional Components

In some embodiments, the polymerizable resin composition may further comprise additional components such as a crosslinking modifier, a polymerization catalyst, a polymerization inhibitor, a light blocker, a plasticizer, a solvent, a surface energy modifier (e.g., a mold releasing agent), a filler, a biologically significant chemical, or any combination thereof.

In some embodiments, the polymerizable resin composition further comprises a crosslinking modifier. The crosslinking modifier may have a sufficient number of polymerizable groups to affect crosslinking. The crosslinking modifier may comprise at least two, at least three, at least four, at least five, or at least six polymerizable groups. The polymerizable groups can be acrylate, methacrylate, or epoxy groups. In some embodiments, the polymerizable resin composition comprises from 0 to 25 wt %, from 0 to 20 wt %, from 0 to 15 wt %, from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the crosslinking modifier. In some embodiments, the crosslinking modifier comprises a (meth)acrylate-terminated polyester, a tricyclodecanediol di(meth)acrylate, a vinyl ester-terminated polyester, a tricyclodecanediol vinyl ester, a derivative thereof, or a combination thereof.

In some embodiments, the polymerizable resin composition further comprises a polymerization catalyst. In some embodiments, the polymerization catalyst comprises a tin catalyst, a platinum catalyst, a rhodium catalyst, a titanium catalyst, a silicon catalyst, a palladium catalyst, a metal triflate catalyst, a boron catalyst, a bismuth catalyst, or any combination thereof. Non-limiting examples of a tin catalyst include di-n-butylbutoxychlorotin, di-n-butyldiacetoxytin, di-n-butyldilauryltin, dimethyldineodecanoatetin, dioctyldilauryltin, tetramethyltin, and dioctylbis(2-ethylhexylmaleate) tin. Non-limiting examples of a platinum catalyst include platinum-divinyltetramethyl-disiloxane complex, platinum-cyclovinylmethyl-siloxane complex, platinum-octanal complex, and platinum carbonyl cyclovinylmethylsiloxane complex. A non-limiting example of a rhodium catalyst includes tris(dibutylsulfide) rhodium trichloride. Non-limiting examples of a titanium catalyst includes titanium isopropoxide, titanium 2-ethyl-hexoxide, titanium chloride triisopropoxide, titanium ethoxide, and titanium diisopropoxide bis(ethylacetoacetate). Non-limiting examples of a silicon catalyst include tetramethylammonium siloxanolate and tetramethylsilylmethyl-trifluoromethanesulfonate. A non-limiting example of a palladium catalyst includes tetrakis(triphenylphosphine) palladium (0). Non-limiting examples of a metal triflate catalyst include scandium trifluoromethanesulfonate, lanthanum trifluoromethanesulfonate, and ytterbium trifluoromethanesulfonate. A non-limiting example of a boron catalyst includes tris(pentafluorophenyl) boron. Non-limiting examples of a bismuth catalyst include bismuth-zinc neodecanoate, bismuth 2-ethylhexanoate, a metal carboxylate of bismuth and zinc, and a metal carboxylate of bismuth and zirconium. In some embodiments, the polymerizable resin composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the polymerization catalyst.

In some embodiments, the polymerizable resin composition of the present disclosure further comprises a polymerization inhibitor in order to stabilize the composition and prevent premature polymerization. In some embodiments, the polymerization inhibitor is oxygen or oxygen in combination with other compounds such as phenol compounds. In some embodiments, the polymerization inhibitor is a phenolic compound (e.g., butylated hydroxytoluene (BHT)). In some embodiments, the polymerization inhibitor is a stable radical (e.g., 2,2,4,4-tetramethylpiperidinyl-1-oxy radical, 2,2-diphenyl-1-picrylhydrazyl radical, galvinoxyl radical, or triphenylmethyl radical). In some embodiments, more than one polymerization inhibitor is present in the curable composition. In some embodiments, the polymerization inhibitor polymerization inhibitor is an antioxidant (e.g., vitamin E), a hindered amine light stabilizer (HAL), a hindered phenol, or a deactivated radical (e.g., a peroxy compound). In some embodiments, the polymerization inhibitor is selected from the group consisting of 4-tert-butylpyrocatechol, tert-butylhydroquinone, 1,4-benzoquinone, 6-tert-butyl-2,4-xylenol, 2-tertbutyl-1,4-benzoquinone, 2,6-di-tert-butyl-p-cresol, 2,6-ditert-butylphenol, 1,1-diphenyl-2-picrylhydrazyl free radical, hydroquinone, 4-methoxyphenol, phenothiazine, any derivative thereof, and any combination thereof. In some embodiments, the polymerizable resin composition comprises from 0 to 1000 ppm, from 0 to 900 ppm, from 0 to 800 ppm, from 0 to 700 ppm, from 0 to 600 ppm, from 0 to 500 ppm, from 0 to 400 ppm, from 0 to 300 ppm, from 0 to 200 ppm, or from 0 to 100 ppm, based on the total weight of the composition, of the polymerization inhibitor.

In some embodiments, the polymerizable resin composition further comprises a light blocker. The light blocker can absorb irradiation and prevent or decrease the rate of polymerization or degradation, and its addition to the polymerizable composition can increase the resolution of printable materials. In certain embodiments, the light blocker comprises a hydroquinone, 1,4-dihydroxybenzene, a compound belonging to the HALS (hindered-amine light stabilizer) family, a benzophenone, a benzotriazole, any derivative thereof, or any combination thereof. In some embodiments, the light blocker comprises 2,2′-dihydroxy-4-methoxybenzophenone. In certain embodiments, the light blocker is selected from the group consisting of Michler's ketone, 4-Allyloxy-2-hydroxybenzophenone 99%, 2-(2H-benzotriazol-2-yl)-4,6-bis(1-methyl-1-phenylethyl) phenol powder, 2-(2H-benzotriazol-2-yl)-4,6-di-tert-pentylphenol, 2-(2H-benzotriazol-2-yl)-6-dodecyl-4-methylphenol, 2-[3-(2H-benzotriazol-2-yl)-4-hydroxyphenyl]ethyl methacrylate, 2-(2H-benzotriazol-2-yl)-4-methyl-6-(2-propenyl) phenol, 2-(2H-benzotriazol-2-yl)-4-(1,1,3,3-tetramethylbutyl) phenol, 2-(4-benzoyl-3-hydroxyphenoxy) ethyl acrylate, 3,9-bis(2,4-dicumylphenoxy)-2,4,8,10-tetraoxa-3,9-diphosphaspiro[5.5]undecane, bis(octadecyl) hydroxylamine powder, 3,9-bis(octadecyloxy)-2,4,8,10-tetraoxa-3,9-diphosphaspiro[5.5]undecane, bis(1-octyloxy-2,2,6,6-tetramethyl-4-piperidyl) sebacate, bis(2,2,6,6-tetramethyl-4-piperidyl) sebacate, 2-tert-butyl-6-(5-chloro-2H-benzotriazol-2-yl)-4-methylphenol, 2-tert-Butyl-4-ethylphenol, 5-chloro-2-hydroxybenzophenone, 5-chloro-2-hydroxy-4-methylbenzophenone, 2,4-di-tert-butyl-6-(5-chloro-2H-benzotriazol-2-yl) phenol, 2,6-di-tert-butyl-4-(dimethylaminomethyl) phenol, 3′,5′-dichloro-2′-hydroxyacetophenone, didodecyl 3,3′-thiodipropionate, 2,4-dihydroxybenzophenone, 2,2′-dihydroxy-4-methoxybenzophenone, 2′, 4′-dihydroxy-3′-propylacetophenone, 2,3-dimethylhydroquinone, 2-(4,6-diphenyl-1,3,5-triazin-2-yl)-5-[(hexyl)oxy]-phenol, 5-ethyl-1-aza-3,7-dioxabicyclo[3.3.0]octane, ethyl 2-cyano-3,3-diphenylacrylate, 2-ethylhexyl 2-cyano-3,3-diphenylacrylate, 2-ethylhexyl trans-4-methoxycinnamate, 2-ethylhexyl salicylate, 2-hydroxy-4-(octyloxy)benzophenone, methyl anthranilate, 2-methoxyhydroquinone, methyl-p-benzoquinone, 2,2′-methylenebis[6-(2H-benzotriazol-2-yl)-4-(1,1,3,3-tetramethylbutyl) phenol], 2,2′-methylenebis(6-tert-butyl-4-ethylphenol), 2,2′-methylenebis(6-tert-butyl-4-methylphenol), 5,5′-methylenebis(2-hydroxy-4-methoxybenzophenone), methylhydroquinone, 4-nitrophenol sodium salt hydrate, octadecyl 3-(3,5-di-tert-butyl-4-hydroxyphenyl) propionate, pentaerythritol tetrakis(3,5-di-tert-butyl-4-hydroxyhydrocinnamate), 2-phenyl-5-benzimidazolesulfonic acid, poly[6-[(1,1,3,3-tetramethylbutyl) amino]-s-triazine-2,4-diyl]-[(2,2,6,6-tetramethyl-4-piperidyl) imino]-hexamethylene-[(2,2,6,6-tetramethyl-4-piperidyl) imino], sodium d-isoascorbate monohydrate, tetrachloro-1,4-benzoquinone, triisodecyl phosphite, 1,3,5-trimethyl-2,4,6-tris(3,5-di-tert-butyl-4-hydroxybenzyl)benzene, tris(4-tert-butyl-3-hydroxy-2,6-dimethylbenzyl) isocyanurate, tris(2,4-di-tert-butylphenyl) phosphite, 1,3,5-tris(2-hydroxyethyl) isocyanurate, and tris(nonylphenyl) phosphite. In some embodiments, the light blocker comprises 2-(2′-hydroxy-phenyl benzotriazole), 2,2′-dihydroxy-4-methoxybenzophenone, 9,10-diethoxyanthracene, a hydroxyphenyltriazine, an oxanilide, a benzophenone, or a combination thereof.

In some embodiments, the light blocker has a maximum wavelength absorbance between 200 and 300 nm, between 300 and 400 nm, between 400 and 500 nm, between 500 and 600 nm, between 600 and 700 nm, between 700 and 800 nm, between 800 and 900 nm, between 150 and 200 nm, between 200 and 250 nm, between 250 and 300 nm, between 300 and 350 nm, between 350 and 400 nm, between 400 and 450 nm, between 450 and 500 nm, between 500 and 550 nm, between 550 and 600 nm, between 600 and 650 nm, between 650 and 700 nm, or between 700 and 750 nm. In some embodiments, the light blocker has a maximum wavelength absorbance between 300 to 500 nm, such as 300 to 400 nm or 350 to 480 nm. In some embodiments, the light block is a UV blocker absorbing light in the UV region.

In some embodiments, the polymerizable resin composition comprises from 0 to 20 wt %, from 0 to 15 wt %, from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the light blocker. In preferred embodiments, the polymerizable resin composition comprises from 0.01 to 10 wt % of the light blocker.

In some embodiments, the polymerizable resin composition further comprises a filler for improving the mechanical properties of the cured resin. In some embodiments, the filler comprises a glass filler (e.g., glass beads, short glass fibers, or long glass fibers), barium sulfate, cellulose, lignin, a derivative thereof, or a combination thereof.

In some embodiments, the polymerizable resin composition further comprises a surface energy modifier. In some embodiments, the surface energy modifier can aid the process of releasing a polymer from a mold. In some embodiments, the surface energy modifier can act as an antifoaming agent. In some embodiments, the surface energy modifier comprises a defoaming agent, a deaeration agent, a hydrophobization agent, a leveling agent, a wetting agent, or an agent to adjust the flow properties of the polymerizable resin composition. In some embodiments, the surface energy modifier comprises an alkoxylated surfactant, a silicone surfactant, a sulfosuccinate, a fluorinated polyacrylate, a fluoropolymer, a silicone, a star-shaped polymer, an organomodified silicone, or any combination thereof.

In some embodiments, the polymerizable resin composition further comprises a plasticizer. A plasticizer can be a nonvolatile material that can reduce interactions between polymer chains, which can decrease glass transition temperature, melt viscosity, and elastic modulus. In some embodiments, the plasticizer comprises a dicarboxylic ester plasticizer, a tricarboxylic ester plasticizer, a trimellitate, an adipate, a sebacate, a maleate, or a bio-based plasticizer. In some embodiments, the plasticizer comprises a dicarboxylic ester or a tricarboxylic ester comprising a dibasic ester, a phthalate, bis(2-ethylhexyl) phthalate (DEHP), bis(2-propylheptyl) phthalate (DPHP), diisononyl phthalate (DINP), di-n-butyl phthalate (DBP), butyl benzyl phthalate (BBzP), diisodecyl phthalate (DIDP), dioctyl phthalate (DOP), diisooctyl phthalate (DIOP), diethyl phthalate (DEP), diisobutyl phthalate (DIBP), di-n-hexyl phthalate, a derivative thereof, or a combination thereof. In some embodiments, the plasticizer comprises a trimellitate comprising trimethyl trimellitate (TMTM), tri-(2-ethylhexyl) trimellitate (TEHTM), tri-(n-octyl,n-decyl) trimellitate (ATM), tri-(heptyl,nonyl) trimellitate (LTM), n-octyl trimellitate (OTM), trioctyl trimellitate, a derivative thereof, or a combination thereof. In some embodiments, the plasticizer comprises an adipate comprising bis(2-ethylhexyl) adipate (DEHA), dimethyl adipate (DMAD), monomethyl adipate (MMAD), dioctyl adipate (DOA), Bis[2-(2-butoxyethoxy)ethyl]adipate, dibutyl adipate, diisobutyl adipate, diisodecyl adipate, a derivative thereof, or a combination thereof. In some embodiments, the plasticizer comprises a sebacate comprising dibutyl sebacate (DBS), bis(2-ethylhexyl) sebacate, diethyl sebacate, dimethyl sebacate, a derivative thereof, or a combination thereof. In some embodiments, the plasticizer comprises a maleate comprising Bis(2-ethylhexyl) maleate, dibutyl maleate, diisobutyl maleate, a derivative thereof, or a combination thereof. In some embodiments, the plasticizer comprises a bio-based plasticizer comprising an acetylated monoglyceride, an alkyl citrate, a methyl ricinoleate, or a green plasticizer. In some embodiments, the alkyl citrate is selected from the group consisting of triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, a derivative thereof, or a combination thereof. In some embodiments, the green plasticizer is selected from the group consisting of epoxidized soybean oil, epoxidized vegetable oil, epoxidized esters of soybean oil, a derivative thereof, or a combination thereof. In some embodiments, the plasticizer comprises an azelate, a benzoate (e.g., sucrose benzoate), a terephthalate (e.g., dioctyl terephthalate), 1,2-cyclohexane dicarboxylic acid diisononyl ester, alkyl sulphonic acid phenyl ester, a sulfonamide (e.g., N-ethyl toluene sulfonamide, N-(2-hydroxypropyl)benzene sulfonamide, N-(n-butyl)benzene sulfonamaide), an organophosphate (e.g., tricresyl phosphate or tributyl phosphate), a glycol (e.g., triethylene glycol dihexanoate or tetraethylene glycol diheptanoate), a polyether, a polymeric plasticizer, polybutene, a derivative thereof, or a combination thereof.

In some embodiments, the polymerizable resin composition further comprises a solvent. In some embodiments, the solvent comprises a nonpolar solvent. In certain embodiments, the nonpolar solvent comprises pentane, cyclopentane, hexane, cyclohexane, benzene, toluene, 1,4-dioxane, chloroform, diethyl ether, dichloromethane, a derivative thereof, or a combination thereof. In some embodiments, the solvent comprises a polar aprotic solvent. In certain embodiments, the polar aprotic solvent comprises tetrahydrofuran, ethyl acetate, acetone, dimethylformamide, acetonitrile, DMSO, propylene carbonate, a derivative thereof, or a combination thereof. In some embodiments, the solvent comprises a polar protic solvent. In certain embodiments, the polar protic solvent comprises formic acid, n-butanol, isopropyl alcohol, n-propanol, t-butanol, ethanol, methanol, acetic acid, water, a derivative thereof, or a combination thereof. In preferred embodiments, the polymerizable resin composition comprises less than 90 wt %, based on the total weight of the composition, of the solvent.

In some embodiments, the polymerizable resin composition further comprises a biologically significant chemical. In some embodiments, the biologically significant chemical comprises a hormone, an enzyme, an active pharmaceutical ingredient, an antibody, a protein, a drug, or any combination thereof. In some embodiments, the biologically significant chemical comprises a pharmaceutical composition, a chemical, a gene, a polypeptide, an enzyme, a biomarker, a dye, a compliance indicator, an antibiotic, an analgesic, a medical grade drug, a chemical agent, a bioactive agent, an antibacterial, an antibiotic, an anti-inflammatory agent, an immune-suppressive agent, an immune-stimulatory agent, a dentinal desensitizer, an odor masking agent, an immune reagent, an anesthetic, a nutritional agent, an antioxidant, a lipopolysaccharide complexing agent, or a peroxide.

In some embodiments, the added component (e.g., a crosslinking modifier, a polymerization catalyst, a polymerization inhibitor, a light blocker, a plasticizer, a solvent, a surface energy modifier, a pigment, a dye, a filler, or a biologically significant chemical) is functionalized so that it can be incorporated into the polymer network so that it cannot readily be extracted from the final cured material. In certain embodiments, the polymerization catalyst, polymerization inhibitor, light blocker, plasticizer, surface energy modifier, pigment, dye, and/or filler, are functionalized to facilitate their incorporation into the cured polymeric material. A polymer network, as used herein, can refer to a polymer composition comprising a plurality of polymer chains wherein a large portion (e.g., >80%) and optionally all the polymer chains are interconnected, for example via covalent crosslinking, to form a single polymer composition. In an embodiment, there is provided a radiopaque polymer in the form of a crosslinked network in which at least some of the crosslinks of the network structure are formed by covalent bonds.

### Polymerizable Resin Composition Properties

Polymerizable resin compositions of the present disclosure can be characterized by one or more properties. In some embodiments, a polymerizable resin composition can have a viscosity from about 30 cP to about 50,000 cP at a printing temperature. In some embodiments, the polymerizable resin composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. In some embodiments, the polymerizable resin composition has a viscosity less than 15,000 cP at 25° C. In some embodiments, the polymerizable resin composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the polymerizable resin composition has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C.

The polymerizable resin composition of the present disclosure can be capable of being 3D printed at a temperature greater than 25° C. In some cases, the printing temperature is at least about 30° C., 40° C., 50° C., 60° C., 80° C., or 100° C. As described herein, a reactive diluent of this disclosure can have a low vapor pressure and/or mass loss at the printing temperature, thereby providing improved printing conditions compared to conventional compositions used in additive manufacturing.

In some embodiments, the polymerizable resin composition herein has a melting temperature greater than room temperature. In some embodiments, the polymerizable resin composition has a melting temperature greater than 20° C., greater than 25° C., greater than 30° C., greater than 35° C., greater than 40° C., greater than 45° C. greater than 50° C., greater than 55° C., greater than 60° C., greater than 65° C., greater than 70° C., greater than 75° C., or greater than 80° C. In some embodiments, the polymerizable resin composition has a melting temperature from 20° C. to 250° C., from 30° C. to 180° C., from 40° C. to 160° C., or from 50° C. to 140° C. In some embodiments, the polymerizable resin composition has a melting temperature greater than 60° C. In other embodiments, the polymerizable resin composition has a melting temperature from 80° C. to 110° C. In some instances, a polymerizable resin composition can have a melting temperature of about 80° C. before polymerization, and after polymerization, the resulting polymeric material can have a melting temperature of about 100° C.

In certain instances, it may be advantageous that the polymerizable resin composition is in a liquid phase at an elevated temperature. As an example, a conventional polymerizable resin composition can comprise polymerizable components that may be viscous at a process temperature, and thus can be difficult to use in the fabrication of objects (e.g., using 3D printing). As a solution for that technical problem, the present disclosure provides polymerizable resin compositions comprising photopolymerizable components described herein that can melt at an elevated temperature, e.g., at a temperature of fabrication (e.g., during 3D printing), and can have a decreased viscosity at the elevated temperature, which can make such polymerizable compositions more applicable and usable for uses such as 3D printing. Hence, in some embodiments, provided herein are polymerizable resin compositions that are a liquid at an elevated temperature. In some embodiments, the elevated temperature is at or above the melting temperature (Tm) of the polymerizable resin compositions. In certain embodiments, the elevated temperature is a temperature in the range from about 40° C. to about 100° C., from about 60° C. to about 100° C., from about 80° C. to about 100° C., from about 40° C. to about 150° C., or from about 150° C. to about 350° C. In some embodiments, the elevated temperature is a temperature above about 40° C., above about 60° C., above about 80° C., or above about 100° C. In some embodiments, the polymerizable resin composition herein is a liquid at an elevated temperature with a viscosity less than about 50 Pa·s, less than 2 about 0 Pa·s, less than about 10 Pa·s, less than about 5 Pa·s, or less than about 1 Pa·s. In some embodiments, the polymerizable resin composition herein is a liquid at an elevated temperature of above about 40° C. with a viscosity less than about 20 Pa·s. In yet other embodiments, a polymerizable resin composition herein is a liquid at an elevated temperature of above about 40° C. with a viscosity less than about 1 Pa·s.

In some embodiments, at least a portion of the polymerizable resin composition herein has a melting temperature below about 100° C., below about 90° C., below about 80° C., below about 70° C., or below about 60° C. In some embodiments, at least a portion of a polymerizable resin composition herein melts at an elevated temperature between about 100° C. and about 20° C., between about 90° C. and about 20° C., between about 80° C. and about 20° C., between about 70° C. and about 20° C., between about 60° C. and about 20° C., between about 60° C. and about 10° C., or between about 60° C. and about 0° C.

The polymerizable resin composition of the present disclosure can comprise less than about 20 wt % or less than about 10 wt % hydrogen bonding units. In some embodiments, a polymerizable resin composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units.

In various embodiments, the polymerizable resin composition herein as well as its photopolymerizable components can be biocompatible, bioinert, or a combination thereof. In various instances, the photopolymerizable compounds of a composition herein can have biocompatible and/or bioinert metabolic (e.g., hydrolysis) products.

### Polymeric Materials

In some embodiments, the present disclosure provides polymeric materials formed from the polymerizable resin compositions disclosed herein. In preferred embodiments, the polymeric material is formed from the polymerizable resin compositions disclosed herein with additive manufacturing. In some embodiments, the polymeric material is prepared by a process comprising: providing a polymerizable resin composition as described herein; and forming the polymeric material from the polymerizable resin composition with additive manufacturing. In some preferred embodiments, the polymeric material is prepared by a process comprising: providing a polymerizable resin composition comprising an oligomer having a number-average molecular weight of greater than 3,000 Da, a reactive diluent, an IR absorbing marking additive, and an initiator, wherein the polymerizable resin composition comprises less than 20 wt % hydrogen bonding units and has a viscosity less than or equal to 15,000 cP at 25° C.; and forming the polymeric material from the polymerizable resin composition with additive manufacturing. In certain preferred embodiments, the polymeric material is prepared by a process comprising: providing a polymerizable resin composition comprising an oligomeric or polymeric telechelic compound; a reactive diluent; an IR absorbing marking additive; and a photoinitiator, wherein the polymerizable resin composition comprises less than 10 wt % hydrogen bonding units; and forming the polymeric material from the polymerizable resin composition with additive manufacturing.

In some embodiments, the present disclosure provides a polymeric material having less than 10 wt % hydrogen bonding units, wherein the polymeric material is characterized by one or more of: a tensile modulus greater than or equal to 200 MPa after 24 hours in a wet environment at 37° C.; a flexural stress of greater than or equal to 1.5 MPa remaining after 24 hours in a wet environment at 37° C.; a hardness from 60 Shore A to 85 Shore D after 24 hours in a wet environment at 37° C.; an elongation at break greater than or equal to 15% before 24 hours in a wet environment at 37° C.; and an elongation at break greater than or equal to 15% after 24 hours in a wet environment at 37° C. In preferred embodiments, the polymeric material is formed from the polymerizable resin compositions disclosed herein. Young's modulus is calculated with an algorithm that breaks the relevant portion of a stress strain curve into 6 regions with 0% overlap and applies a least square fitting to determine the slope. The pair of consecutive regions that have the highest slope sum are determined. From this pair, the modulus is assigned to region with the highest slope.

Property values of the polymeric material can be determined, for example, by using the following methods:
stress relaxation properties can be assessed using an RSA-G2 instrument from TA Instruments, with a 3-point bending, according to ASTM D790; stress relaxation can be measured at 30° C. and submerged in water, and reported as either the remaining load after 24 hours, and/or as the percent (%) of initial load;
storage modulus can be measured at 37° C. and is reported in MPa;
T_{g} of the cured polymeric material can be assessed using dynamic mechanical analysis (DMA) and is provided herein as the tan & peak when run at 1 hz with a temperature ramp of 2° C. a minute;
tensile modulus, tensile strength, elongation at yield and elongation at break can be assessed according to ISO 527-2 5B;
tensile strength at yield, elongation at break, tensile strength, and Young's modulus can be assessed according to ASTM D1708 or ASTM D638; and
flexural stress remaining after 24 hours in wet environment at 37° C. (“flexural stress remaining”) can be assessed according to ASTM E328.

In some embodiments, the polymeric material is characterized by a tensile stress-strain curve that displays a yield point after which the test specimen continues to elongate, but there is no increase in load. Such yield point behavior typically occurs “near” the glass transition temperature, where the material is between the glassy and rubbery regimes and may be characterized as having viscoelastic behavior. In embodiments, viscoelastic behavior is observed in the temperature range 20° C. to 40° C. The yield stress is determined at the yield point. In some embodiments, the yield point follows an elastic region in which the slope of the stress-strain curve is constant or nearly constant. In embodiments, the modulus is determined from the initial slope of the stress-strain curve or as the secant modulus at 1% strain (e.g. when there is no linear portion of the stress-strain curve). The elongation at yield is determined from the strain at the yield point. When the yield point occurs at a maximum in the stress, the ultimate tensile strength is less than the yield strength. For a tensile test specimen, the strain is defined by In (1/1₀), which may be approximated by (1-1₀)/1₀ at small strains (e.g. less than approximately 10%) and the elongation is 1/1₀, where 1 is the gauge length after some deformation has occurred and lo is the initial gauge length. The mechanical properties can depend on the temperature at which they are measured. The test temperature may be below the expected use temperature for a dental appliance such as 35° C. to 40° C. In some embodiments, the test temperature is 23±2° C.

Properties of the polymeric material can be determined after a soak time in a wet environment. Determination of values after a soak time in a wet environment can be conducted on a 1-mm thick sample. For example, material properties of a polymeric material disclosed herein can be determined by obtaining a 1-mm thick sample of said polymeric material, and soaking in a wet environment for 24 hours at 37° C. (i.e., the material after 24 hours in a wet environment at 37° C.).

In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material has an elongation at break greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material has an elongation at break greater than 15% before and after 24 hours in a wet environment at 37° C.

In some embodiments, the polymeric material has a tensile strength at yield from 1 MPa to 100 MPa, from 5 MPa to 85 MPa, from 10 MPa to 75 MPa, from 15 MPa to 65 MPa, from 20 MPa to 55 MPa, or from 25 MPa to 45 MPa after 24 hours in a wet environment at 37° C. In preferred embodiments, the polymeric material has a tensile strength at yield from 10 MPa to 55 MPa after 24 hours in a wet environment at 37° C. In some embodiments, the polymeric material is characterized by a tensile strength at yield greater than or equal to 0.1 MPa, greater than or equal to 0.5 MPa, greater than or equal to 1 MPa, greater than or equal to 2 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, or greater than or equal to 10 MPa after 24 hours in a wet environment at 37° C. In preferred embodiments, the polymeric material is characterized by a tensile strength at yield greater than or equal to 5 MPa after 24 hours in a wet environment at 37° C.

In some embodiments, the polymeric material has an ultimate tensile strength from 10 MPa to 100 MPa, from 15 MPa to 80 MPa, from 20 MPa to 60 MPa, from 25 MPa to 50 MPa, from 25 MPa to 45 MPa, from 25 MPa to 40 MPa, from 30 MPa to 45 MPa, or from 30 MPa to 40 MPa after 24 hours in a wet environment at 37° C. In preferred embodiments, the polymeric material has an ultimate tensile strength from 10 MPa to 50 MPa after 24 hours in a wet environment at 37° C.

In some embodiments, the polymeric material has a tensile modulus from 100 MPa to 3000 MPa, from 200 MPa to 3000 MPa, from 250 MPa to 2750 MPa, from 400 MPa to 2500 MPa, from 600 MPa to 2250 MPa, or from 800 MPa to 2000 MPa after 24 hours in a wet environment at 37° C. In some embodiments, the polymeric material has a tensile modulus of greater or equal to 100 MPa, greater or equal to 200 MPa, greater or equal to 300 MPa, greater or equal to 400 MPa, greater or equal to 500 MPa, greater or equal to 600 MPa, greater or equal to 700 MPa, greater or equal to 800 MPa, greater or equal to 900 MPa, greater or equal to 1000 MPa, greater or equal to 1100 MPa, greater or equal to 1200 MPa, greater or equal to 1300 MPa, greater or equal to 1400 MPa, or greater or equal to 1500 MPa after 24 hours in a wet environment at 37° C. In some preferred embodiments, the polymeric material has a tensile modulus of greater than 200 MPa after 24 hours in a wet environment at 37° C. In some preferred embodiments, the polymeric material has a tensile modulus from 1.0 GPa to 1.4 GPa after 24 hours in a wet environment at 37° C. In some preferred embodiments, the polymeric material is characterized by a tensile modulus greater than or equal to 200 MPa after 24 hours in a wet environment at 37° C.

In some embodiments, the polymeric material has a flexural stress relaxation remaining (“flexural stress remaining”) greater than or equal to 5%, greater than or equal to 10%, greater than or equal to 15%, greater than or equal to 20%, greater than or equal to 35%, greater than or equal to 40%, greater than or equal to 45%, greater than or equal to 50%, greater than or equal to 55%, or greater than or equal to 60% after 24 hours in a wet environment at 37° C. In some preferred embodiments the polymeric material has a flexural stress remaining of greater than or equal to 10% after 24 hours in a wet environment at 37° C. In some embodiments, the polymeric material is characterized by a flexural stress remaining from 5% to 45%, from 10% to 45%, from 15% to 45%, from 20% to 45%, from 25% to 45%, or from 30% to 45% of the initial load after 24 hours in a wet environment at 37° C. In some preferred embodiments, the polymeric material is characterized by a flexural stress remaining from 20% to 45% of the initial load after 24 hours in a wet environment at 37° C.

In some embodiments, the polymeric material is characterized by a flexural stress remaining from 0.01 MPa to 15 MPa, from 0.05 MPa to 15 MPa, from 0.1 MPa to 15 MPa, from 0.5 MPa to 15 MPa, from 1 MPa to 15 MPa, from 2 MPa to 15 MPa, from 3 MPa to 15 MPa, from 4 MPa to 15 MPa, from 5 MPa to 15 MPa, or from 10 MPa to 15 MPa after 24 hours in a wet environment at 37° C. In some preferred embodiments, the polymeric material is characterized by a flexural stress remaining from 2 MPa to 15 MPa after 24 hours in a wet environment at 37° C. In some embodiments, the polymeric material is characterized by a flexural stress remaining of greater than or equal to 0.1 MPa, greater than or equal to 0.5 MPa, greater than or equal to 1 MPa, greater than or equal to 1.5 MPa, greater than or equal to 2 MPa, greater than or equal to 2.5 MPa, greater than or equal to 3 MPa, greater than or equal to 4 MPa, greater than or equal to 5 MPa, greater than or equal to 6 MPa, greater than or equal to 7 MPa, greater than or equal to 8 MPa, greater than or equal to 9 MPa, greater than or equal to 10 MPa, or greater than or equal to 15 MPa after 24 hours in a wet environment at 37° C. In some preferred embodiments, the polymeric material is characterized by a flexural stress remaining of greater than or equal to 1.5 MPa after 24 hours in a wet environment at 37° C.

In certain embodiments, it is advantageous that the polymeric material have a high flexural stress remaining, forming relatively stiff materials. In some applications relating to use of hard materials (e.g., aeronautical engineering, medical implants), a polymeric material formed from the polymerizable resin compositions disclosed herein would be advantageous due to the availability of conventional 3D printers to form these polymeric materials having the desired characteristics. In some embodiments, the polymeric material has a flexural modulus remaining of 50 MPa or more, 60 MPa or more, 70 MPa or more, 80 MPa or more, 90 MPa or more, 100 MPa or more, 125 MPa or more, or 150 MPa or more after 24 hours in a wet environment at 37° C.

In certain other embodiments, it is advantageous that the polymeric material have a relatively low flexural stress remaining, forming materials that are not overly-stiff. In some embodiments, the polymeric material has a flexural modulus remaining of 80 MPa or less, 70 MPa or less, 60 MPa or less, 55 MPa or less, 50 MPa or less, or 45 MPa or less after 24 hours in a wet environment at 37° C.

In some embodiments, a polymeric material will have a flexural stress remaining after a period of time of use. As a non-limiting example, an orthodontic appliance (e.g., an aligner) can be formed of a polymeric material having a high flexural stress. In some embodiments, following application of the appliance to the teeth of a patient, there can be a significant and fast decrease of flexural stress (e.g., over the course of minutes). Such decreases in flexural stress can follow an exponential curve of decrease leading towards an asymptote during the intended lifetime of the appliance (e.g., over the course of weeks for an orthodontic appliance such as an aligner). Orthodontic appliances may have an initial period of discomfort that, following a period of use, decreases corresponding with a decrease of flexural stress remaining. In some embodiments, the polymeric material has a flexural stress remaining of 90 MPa or less, 85 MPa or less, 80 MPa or less, 75 MPa or less, 70 MPa or less, 65 MPa or less, 60 MPa or less, 55 MPa or less, or 50 MPa or less after a time period of use. In preferred embodiments, the polymeric material has a flexural stress remaining of 80 MPa or less after a time period of use. In some embodiments, the time period of use is 1 minute, 5 minutes, 10 minutes, 30 minutes, 1 hour, or 24 hours. As a non-limiting example, an aligner composed of polymeric material placed onto a patient's teeth that is removed after 10 minutes and has a flexural stress of 70 MPa would have a polymeric material characterized by a flexural stress remaining of 70 MPa after a time period of use, wherein said time period is 10 minutes.

In certain embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% after 24 hours in a wet environment at 37° C. (i.e., following exposure to a wet environment for 24 hours). In some embodiments, the polymeric material is characterized by an elongation at yield of greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, greater than or equal to 15%, or greater than or equal to 20% before 24 hours in a wet environment at 37° C. In preferred embodiments, the polymeric material is characterized by an elongation at yield of greater than or equal to 4% before and after 24 hours in a wet environment at 37° C.

In some embodiments, the polymeric material has a maximum force at 5% strain greater than or equal to 3 pound-force per 3.57 cm². As a non-limiting example, the sample is a rectangular slab having a width of 2.1 cm and a distance between support of 1.7 cm. In some embodiments, the polymeric material has a remaining force greater than 0.1 pound-force per 3.57 cm² after being submerged for 24 hours in a wet environment having a temperature of 37° C.

In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% after 24 hours in a wet environment at 37° C. In some embodiments, the polymeric material is characterized by an elongation at yield from 1% to 10%, from 2% to 10%, from 3% to 10%, from 4% to 10%, from 5% to 10%, from 1% to 15%, from 1% to 20%, or from 1% to 25% before 24 hours in a wet environment at 37° C. In preferred embodiments, the polymeric material is characterized by an elongation at yield from 4% to 10% before and after 24 hours in a wet environment at 37° C.

In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% after 24 hours in a wet environment at 37° C. In some embodiments, the polymeric material is characterized by an elongation at break of greater than 5%, greater than 10%, greater than 15%, greater than 20%, greater than 25%, greater than 30%, greater than 35%, greater than 40%, greater than 45%, or greater than 50% before 24 hours in a wet environment at 37° C. In preferred embodiments, the polymeric material is characterized by an elongation at break of greater than 15% before and after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% after 24 hours in a wet environment at 37° C. In some embodiments, the polymeric material is characterized by an elongation at break from 5% to 250%, from 10% to 250%, from 15% to 250%, from 20% to 250%, from 25% to 250%, from 30% to 250%, from 35% to 250%, from 40% to 250%, from 45% to 250%, from 50% to 250%, from 75% to 250%, or from 100% to 250% before 24 hours in a wet environment at 37° C. In preferred embodiments, the polymeric material is characterized by an elongation at break from 40% to 250% before and after 24 hours in a wet environment at 37° C.

In some embodiments, the polymeric material is characterized by a storage modulus from 0.1 MPa to 4000 MPa, from 50 MPa to 2750 MPa, from 100 MPa to 2500 MPa, from 200 MPa to 2250 MPa, from 300 MPa to 3000 MPa, from 500 MPa to 3000 MPa, from 750 MPa to 3000 MPa, or from 1000 MPa to 3000 MPa after 24 hours in a wet environment at 37° C. In preferred embodiments, the polymeric material is characterized by a storage modulus from 750 MPa to 3000 MPa after 24 hours in a wet environment at 37° C.

In some embodiments, the polymeric material has at least one glass transition temperature (T_{g}) from 0° C. to 150° C. In preferred embodiments, the polymeric material has at least one glass transition temperature greater than 60° C. In even more preferred embodiments, the polymeric material has at least one glass transition temperature greater than 75° C. In some embodiments, the at least one glass transition temperature is from 0° C. to 200° C., from 0° C. to 140° C., from 0° C. to 20° C., from 20° C. to 40° C., from 40° C. to 60° C., from 60° C. to 80° C., from 80° C. to 100° C., from 100° C. to 120° C., from 120° C. to 140° C., from 140° C. to 160° C., from 160° C. to 180° C., from 180° C. to 200° C., from 0° C. to 35° C., from 35° C. to 65° C., from 65° C. to 100° C., from 0° C. to 50° C., or from 50° C. to 100° C. In some embodiments, the polymeric material has at least one glass transition temperature from 0° C. to 10° C., from 10° C. to 20° C., from 20° C. to 30° C., from 30° C. to 40° C., from 40° C. to 50° C., from 50° C. to 60° C., from 60° C. to 70° C., from 70° C. to 80° C., or from 80° C. to 90° C. In some embodiments, the polymeric material has at least one glass transition temperature from −100° C. to 40° C., from −80° C. to 10° C., from −70° C. to 0° C., from −70° C. to −10° C., from −70° C. to −20° C., from −70° C. to −30° C., from −70° C. to −40° C., from −70° C. to −50° C., or from −80° C. to −40° C. In some embodiments, the polymeric material has at least two glass transition temperatures. In certain embodiments, the polymeric material has a first glass transition temperature less than or equal to 40° C. and a second glass transition temperature greater than or equal to 60° C. In some embodiments, the polymeric material has a first glass transition temperature less than or equal to 0° C. and a second glass transition temperature greater than or equal to° 60 C. In some embodiments, the polymeric material has a first glass transition temperature less than or equal to 0° C. and a second glass transition temperature greater than or equal to 75° C. In some embodiments, the polymeric material has a first glass transition temperature less than −20° C. and a second glass transition temperature greater than 80° C.

Low levels of water absorption are favorable for polymeric materials described herein. Water absorption can occur when a polymeric material is exposed to a wet environment (e.g., a patient's mouth using an orthodontic appliance formed from a polymeric material). Properties of the polymeric material can degrade when water absorption reaches a threshold value, typically greater than 22 wt %. It is preferred herein that the polymeric materials have low levels of water uptake. In some embodiments, the polymeric material formed from the polymerizable resin composition comprises a water uptake of less than 25 wt %, less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt %. In preferred embodiments, the polymeric material formed from the polymerizable resin composition comprises a water uptake of less than 2 wt %. In more preferred embodiments, the polymeric material formed from the polymerizable resin composition comprises a water uptake of less than 1 wt %. In even more preferred embodiments, the polymeric material formed from the polymerizable resin composition comprises a water uptake of less than 0.5 wt %. In embodiments described herein, the water uptake is measured after 24 hours in a wet environment at 37° C. In some embodiments, a polymer formed from the oligomer of the resin is hydrophobic. In preferred embodiments, the polymeric material formed from the polymerizable resin composition is hydrophobic.

In some embodiments, the polymeric material is characterized by having a low water uptake. In some embodiments, the polymeric material comprises less than 40 wt %, less than 35 wt %, less than 30 wt %, less than 25 wt %, less than 20 wt %, less than 15 wt %, less than 10 wt %, less than 5 wt %, less than 4 wt %, less than 3 wt %, less than 2 wt %, or less than 1 wt % water after 24 hours in a wet environment at 37° C. In preferred embodiments, the polymeric material comprises less than 2 wt % water after 24 hours in a wet environment at 37° C. In more preferred embodiments, the polymeric material comprises less than 1 wt % water after 24 hours in a wet environment at 37° C. In even more preferred embodiments, the polymeric material comprises less than 0.5 wt % water after 24 hours in a wet environment at 37° C.

The polymeric materials formed from the polymerizable resin compositions can have high conversion rates, or high extent of reactions. In some embodiments, the polymeric material comprises 20-100 wt % of the polymer formed from the oligomer(s) and/or monomer(s) of the polymerizable resin composition. In some embodiments, the polymeric material comprises greater than 20 wt %, greater than 30 wt %, greater than 40 wt %, greater than 50 wt %, greater than 60 wt %, greater than 70 wt %, greater than 80 wt %, greater than 85 wt %, greater than 90 wt %, greater than 95 wt %, greater than 98 wt %, or greater than 99 wt % of the polymer formed from the oligomer(s) and/or monomer(s) of the polymerizable resin composition. In certain embodiments, it is preferable to have a high conversion percentage of oligomer(s) and/or monomer(s) into polymer when forming the polymeric material. In some embodiments, the formed polymer is hydrophobic.

In some embodiments, the polymeric materials formed from the polymerizable resin compositions have high conversion rates of reactive group double bonds (e.g., acrylates or methacrylates) to single bonds, indicating incorporation into the polymeric material. In some embodiments, the conversion of reactive double bonds in the resin to single bonds in the polymeric material can be measured by FTIR (e.g., by measuring relative amounts before and after curing). In some embodiments, the polymeric material formed from the polymerizable resin composition has greater than 60%, greater than 70%, greater than 80%, greater than 90%, or greater than 95% conversion of double bonds to single bonds.

In some embodiments, the polymeric materials formed from the polymerizable resin compositions have low levels of extractable materials (e.g., unreacted monomers from said polymerizable resin composition). The amount of extractable materials can be determined by weight loss of the polymeric material after soaking in water for 1 week, after soaking in ethanol for 48 hours, or after soaking in hexane for 48 hours. A general experiment for determining the amount of extractable material includes the steps of (i) weighing a dried sample of the polymeric material; (ii) soaking the sample in a solvent at a given temperature (e.g., 25° C.) for a period of time; (iii) refreshing the solvent until extraction is completed; (iv) drying the sample in an oven; (v) weighing the extracted sample; and (vi) calculating the weight loss. In some embodiments, the polymeric materials formed from the polymerizable resin composition have less than 5 wt %, less than 4 wt %, less than 3 wt %, less than 2 wt %, less than 1 wt %, less than 0.75 wt %, less than 0.5 wt %, or less than 0.25 wt % extractable materials.

In some embodiments, the polymeric material has less than 20 wt %, less than 15 wt %, less than 10 wt %, less than 9 wt %, less than 8 wt %, less than 7 wt %, less than 6 wt %, less than 5 wt %, less than 4 wt %, less than 3 wt %, less than 2 wt %, or less than 1 wt % hydrogen bonding units, as calculated or measured by weight percentage of hydrogen bonding groups, further described herein. In preferred embodiments, the polymeric material has less than or equal to 10 wt % hydrogen bonding units.

In some cases, the polymeric material comprises a color defined by an L* value between 70 and 95, an a* value of between −11 and 1, and a b* value of between 2 and 22. In some cases, the polymeric material comprises a color defined by an L* value between 78 and 87, an a* value of between −7 and −3, and a b* value of between 8 and 16.

In some embodiments, the polymeric material is clear, substantially clear, mostly clear, or opaque. In certain embodiments, the polymeric material is clear. In certain embodiments, the polymeric material is substantially clear. In certain embodiments, the polymeric material is mostly clear. In some embodiments, greater than 70% of visible light passes through the polymeric material. In certain embodiments, greater than 80% of visible light passes through the polymeric material. In certain embodiments, greater than 90% of visible light passes through the polymeric material. In certain embodiments, greater than 95% of visible light passes through the polymeric material. In certain embodiments, greater than 99% of visible light passes through the polymeric material. Transparency can be measured using a UV-Vis spectrophotometer. In some embodiments, the transparency is measured by measuring the passage of a wavelength of transparency. In some embodiments, greater than 70%, greater than 80%, greater than 90%, greater than 95%, or greater than 99% of the wavelength of transparency can pass through the polymeric material. In some embodiments, the wavelength of transparency is in the visible light range (i.e., from 400 nm to 800 nm), is in the infrared light range, or is in the ultraviolet light range. In some embodiments, the polymeric material does not have color. In other embodiments, the polymeric material appears white, off-white, or mostly transparent with white coloring, as detected by the human eye.

In some embodiments, greater than 20%, greater than 30%, greater than 40%, greater than 50%, greater than 60%, greater than 70%, greater than 80%, greater than 90%, or greater than 95% of visible light passes through the polymeric material after 24 hours in a wet environment at 37° C. In preferred embodiments, greater than 70% of visible light passes through the polymeric material after 24 hours in a wet environment at 37° C.

In some embodiments, the polymeric material is biocompatible, bioinert, or a combination thereof.

In some embodiments, the polymeric material is formed using 3D printing (i.e., by additive manufacturing) using photopolymerization. In certain embodiments, the polymeric material is formed using conventional 3D printers. In some embodiments, the polymeric material can be used in coatings, molds, injection molding machines, or other manufacturing methods that use or could use light during the curing process. In some embodiments, the polymeric material is well suited for applications that require, e.g., solvent resistance, humidity resistance, water resistance, creep resistance, or heat deflection resistance.

### Methods of Use

The present disclosure provides methods of using laser markable polymerizable resin compositions disclosed herein including methods of using laser markable polymerizable resin compositions for forming polymeric materials and devices such as orthodontic devices, as well as methods of using the devices and methods of laser marking the devices.

### Methods of Making Polymeric Materials

The present disclosure provides methods for making the polymeric materials described herein, wherein said polymeric materials are formed by polymerizing (e.g., photocuring) the polymerizable resin compositions comprising an oligomeric or polymeric telechelic compound, a reactive diluent, an IR absorbing marking additive described herein, and optionally one or more additional compositions selected from initiators, T_{g} modifiers, crosslinking modifiers, polymerization inhibitors, solvents, fillers, antioxidants, pigments, colorants, surface modifiers, and mixtures thereof, to obtain an optionally cross-linked polymer. In some embodiments, the method for forming a polymeric material comprises: (i) providing a polymerizable resin composition disclosed herein; and (ii) curing the polymerizable resin composition, forming the polymeric material disclosed herein.

In some embodiments, providing the polymerizable resin composition comprises mixing the components of the polymerizable resin composition.

In some embodiments, curing the polymerizable resin composition comprises exposing the polymerizable resin composition to a light source that initiates and/or facilitates photopolymerization. In some embodiments, a photoinitiator can be used as part of the resin composition to accelerate and/or initiate photopolymerization. In some embodiments, the polymerizable resin composition is exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV) or visible. UV light sources include UVA (wavelength about 400 nanometers (nm) to about 320 nm), UVB (about 320 nm to about 290 nm) or UVC (about 290 nm to about 100 nm). Any suitable source may be used, including laser sources. The source may be broadband or narrowband, or a combination thereof. The light source may provide continuous or pulsed light during the process. Both the length of time the system is exposed to UV light and the intensity of the UV light can be varied to determine the ideal reaction conditions. In certain embodiments, a polymerizable resin composition is cured using an additive manufacturing device to produce the polymeric material. In some embodiments, the polymerizable resin composition herein may be heated to a predefined elevated process temperature ranging from about 50° C. to about 120° C., such as from about 90° C. to about 120° C., before becoming irradiated with light of a suitable wavelength to be absorbed by the photoinitiator, thereby causing activation of the photoinitiator to induce polymerization of the polymerizable resin to obtain a cured polymeric material, which can optionally be crosslinked.

In some embodiments, the methods disclosed herein for forming a polymeric material are part of a high temperature lithography-based photopolymerization process, wherein a polymerizable resin composition (e.g., a photopolymerizable resin composition) that can comprise at least one photoinitiator is heated to an elevated process temperature. The heating may lower the viscosity of the polymerizable resin composition before and/or during curing. Non-limiting examples of high-temperature lithography processes include those processes described in WO 2015/075094, WO 2016/078838 and WO 2018/032022. In some implementations, the high-temperature lithography may involve applying heat to material to temperatures from about 50° C. to about 120° C., such as from about 90° C. to about 120° C., from about 100° C. to about 120° C., from about 105° C. to about 115° C., from about 108° C. to about 110° C., etc. The material may be heated to temperatures greater than about 120° C. It is noted other temperature ranges may be used without departing from the scope and substance of the inventive concepts described herein. Thus, a method for forming a polymeric material according to the present disclosure can offer the possibility of quickly and facilely producing devices, such as orthodontic appliances, by additive manufacturing such as 3D printing using polymerizable resin composition as disclosed herein.

In some embodiments, the methods disclosed herein further comprise heating the polymeric material to an elevated temperature. In certain embodiments, the elevated temperature is from 40° C. to 150° C. In some embodiments, heating the polymeric material to the elevated temperature occurs after curing the polymerizable resin composition. In certain embodiments, a thermal cure occurs by heating the polymeric material comprising a thermal initiator to an elevated temperature following the photo-curing step. In certain embodiments, the polymerizable resin composition is cured using an additive manufacturing device to produce the polymeric material. In some embodiments, the additive manufacturing device is a 3-D printer. In some embodiments, the method further comprises the step of cleaning the polymeric material. In certain embodiments, the cleaning of the polymeric material includes washing and/or rinsing the polymeric material with a solvent, which can remove monomers and undesired impurities from the polymeric material.

As described herein, a polymeric material produced by the methods provided herein can be characterized by one or more of: (i) a storage modulus greater than or equal to 200 MPa; (ii) a flexural stress of greater than or equal to 1.5 MPa remaining after 24 hours in a wet environment at 37° C.; (iii) an elongation at break greater than or equal to 5% before and after 24 hours in a wet environment at 37° C.; (iv) a water uptake of less than 25 wt % when measured after 24 hours in a wet environment at 37° C.; and (v) transmission of at least 30% of visible light through the polymeric material after 24 hours in a wet environment at 37° C. In various cases, such polymeric material can be characterized by at least 2, 3, 4, or all of these properties.

### Fabrication and Use of Orthodontic Appliances

The present disclosure provides devices comprising the polymeric materials generated from the polymerizable resin compositions as described further herein. In some embodiments, the polymeric material is used to create orthodontic appliances intended to be placed in the intraoral cavity of a human. Such orthodontic appliances can be, for example, aligners that help to move teeth to new positions. In some embodiments, the orthodontic appliances can be retainers that help to keep teeth from moving to a new position. In some embodiments, the orthodontic appliances can be expanders used to expand the palate, move the location of the jaw, or prevent snoring of a human.

In some embodiments, the present disclosure provides methods for producing the devices described herein, said devices comprising a polymeric material generated from the polymerizable resin compositions described herein. In some embodiments, the method comprises a step of shaping a polymerizable resin composition into a desirable shape prior to a step of curing the polymerizable resin composition, thereby generating the polymeric material having said desirable shape. In some embodiments, the method comprises a step of shaping a polymerizable resin composition into a desirable shape during a step of curing the polymerizable resin composition, thereby generating the polymeric material having said desirable shape. In some embodiments, the method comprises a step of curing the polymerizable resin composition, thereby forming the polymeric material, then shaping the polymeric material into a desirable shape. In some embodiments, the desirable shape is an orthodontic appliance. In some embodiments, the desirable shape is a device and/or object as disclosed herein. In some embodiments, the shaping step comprises extrusion, production of a sheet, production of a film, melt spinning, coating, injection molding, compression and transfer molding, blow molding, rotational blow molding, thermoforming, casting, or a combination thereof.

In certain embodiments, the present disclosure provides an orthodontic appliance comprising a polymeric material as further described herein. The orthodontic appliance may be an aligner, expander or retainer. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration, optionally according to a treatment plan. As used herein a “plurality of teeth” encompasses two or more teeth.

In many embodiments, one or more posterior teeth comprise one or more of a molar, a premolar or a canine, and one or more anterior teeth comprising one or more of a central incisor, a lateral incisor, a cuspid, a first bicuspid, or a second bicuspid.

The polymerizable resin compositions and cured polymeric materials according to the present disclosure exhibit favorable thermomechanical properties for use as orthodontic appliances, for example, for moving one or more teeth. The addition of the IR absorbing marking additive does not affect the mechanical properties of the orthodontic appliances.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with the polymeric shell appliances as disclosed herein.

The embodiments disclosed herein are well suited for moving one or more teeth of the first group of one or more teeth or moving one or more of the second group of one or more teeth, and combinations thereof.

The embodiments disclosed herein are well suited for combination with one or known commercially available tooth moving components such as attachments and polymeric shell appliances. In many embodiments, the appliance and one or more attachments are configured to move one or more teeth along a tooth movement vector comprising six degrees of freedom, in which three degrees of freedom are rotational and three degrees of freedom are translation.

The present disclosure provides orthodontic systems and related methods for designing and providing improved or more effective tooth moving systems for eliciting a desired tooth movement and/or repositioning teeth into a desired arrangement.

Although reference is made to an appliance comprising a polymeric shell appliance, the embodiments disclosed herein are well suited for use with many appliances that receive teeth, for example appliances without one or more of polymers or shells. The appliance can be fabricated with one or more of many materials such as metal, glass, reinforced fibers, carbon fiber, composites, reinforced composites, aluminum, biological materials, and combinations thereof for example. In some cases, the reinforced composites can comprise a polymer matrix reinforced with ceramic or metallic particles, for example. The appliance can be shaped in many ways, such as with thermoforming or direct fabrication as described herein, for example. Alternatively or in combination, the appliance can be fabricated with machining such as an appliance fabricated from a block of material with computer numeric control machining. Preferably, the appliance is fabricated using a polymerizable resin according to the present disclosure.

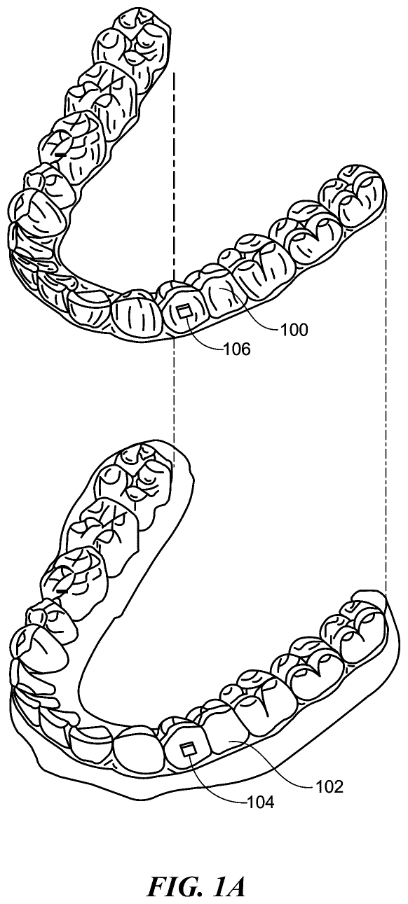

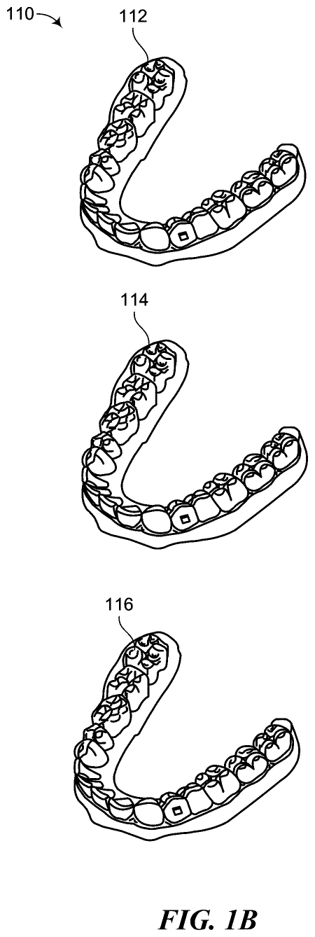

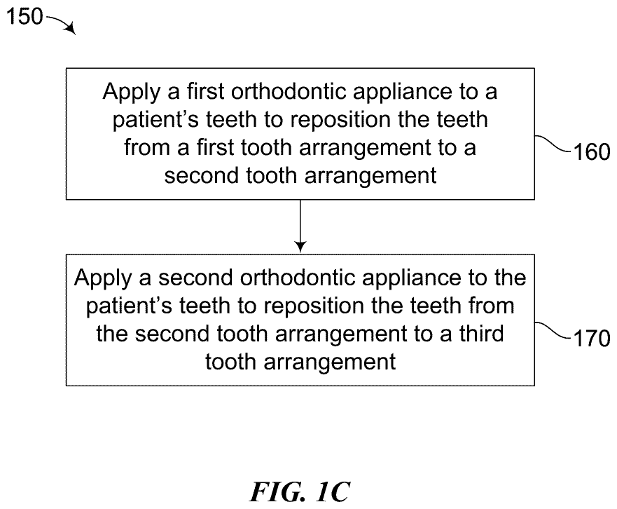

Turning now to the drawings, in which like numbers designate like elements in the various figures, FIG. 1A illustrates an exemplary tooth repositioning appliance or aligner 100 that can be worn by a patient in order to achieve an incremental repositioning of individual teeth 102 in the jaw, and comprises the cured polymeric material disclosed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system 110 including a plurality of appliances 112, 114, 116. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 110 can include a first appliance 112 corresponding to an initial tooth arrangement, one or more intermediate appliances 114 corresponding to one or more intermediate arrangements, and a final appliance 116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 1C illustrates a method 150 of orthodontic treatment using a plurality of appliances, in accordance with embodiments. The method 150 can be practiced using any of the appliances or appliance sets described herein. In step 160, a first orthodontic appliance is applied to a patient's teeth in order to reposition the teeth from a first tooth arrangement to a second tooth arrangement. In step 170, a second orthodontic appliance is applied to the patient's teeth in order to reposition the teeth from the second tooth arrangement to a third tooth arrangement. The method 150 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The various embodiments of the orthodontic appliances presented herein can be fabricated in a wide variety of ways. In some embodiments, the orthodontic appliances herein (or portions thereof) can be produced using direct fabrication, such as additive manufacturing techniques (also referred to herein as “3D printing”) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

Alternatively or in combination, some embodiments of the appliances herein (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In some embodiments, the direct fabrication methods provided herein build up the object geometry in a layer-by-layer fashion, with successive layers being formed in discrete build steps. Alternatively, or in combination, direct fabrication methods that allow for continuous build-up of an object geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of polymerizable resin composition by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a polymerizable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every n^{th} build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively, or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

In some embodiments, the direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. In some embodiments, the direct fabrication techniques described herein can be used to produce appliances with substantially anisotropic material properties (e.g., substantially different strengths along all directions). In some embodiments, the direct fabrication techniques described herein produce appliances with a strength that varies by more than about 0.5%, more than about 1%, more than about 5%, more than about 10%, more than about 15%, more than about 20%, or more than about 25% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

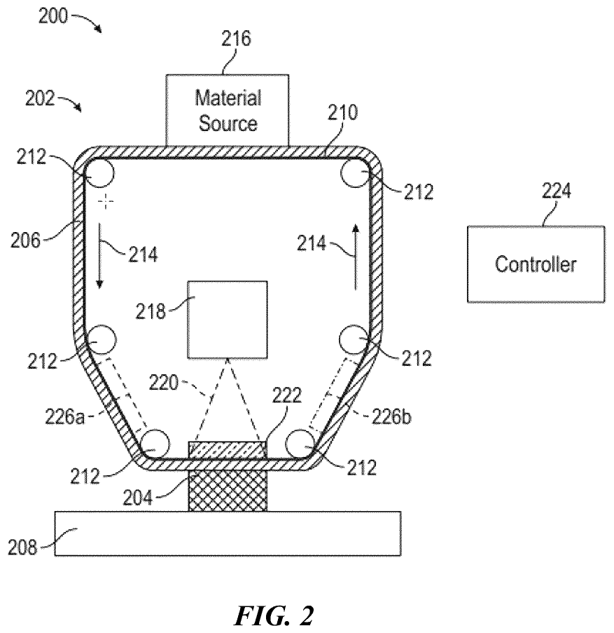

FIG. 2 illustrates a representative example of a system 200 for additive manufacturing configured in accordance with embodiments of the present disclosure. The system 200 can be used to fabricate any embodiment of the objects described herein. For example, the system 200 can be used to produce an object using an additive manufacturing process (e.g., 3D printing).

The system 200 includes a printer assembly 202 configured to fabricate an additively manufactured object 204 (“object 204”) using any of the additive manufacturing processes described herein. The printer assembly 202 is configured to deposit a curable material 206 (e.g., a polymeric resin, polymerizable composition, or other solidifiable precursor material) on a build platform 208 (e.g., a tray, plate, film, sheet, or other planar substrate) to form the object 204. In the illustrated embodiment, the printer assembly 202 includes a carrier film 210 configured to deliver the curable material 206 to the build platform 208. The carrier film 210 can be a flexible loop of material having an outer surface and an inner surface. The outer surface of the carrier film 210 can adhere to and carry a thin layer of the curable material 206. The inner surface of the carrier film 210 can contact one or more rollers 212 that rotate to move the carrier film 210 in a continuous loop trajectory, e.g., along the direction indicated by arrow 214. The printer assembly 202 can also include a material source 216 (shown schematically) configured to apply the curable material 206 to the carrier film 210. In the illustrated embodiment, the material source 216 is located at the upper portion of the printer assembly 202. In other embodiments, however, the material source 216 can be at a different location in the printer assembly 202. The material source 216 can include nozzles, ports, reservoirs, etc., that deposit the curable material 206 onto the outer surface of the carrier film 210. The material source 216 can also include one or more blades (e.g., doctor blades, recoater blades) that smooth the deposited curable material 206 into a relatively thin, uniform layer. For example, the curable material 206 can be formed into a layer having a thickness within a range from 200 microns to 300 microns, or any other desired thickness.

The curable material 206 can be conveyed by the carrier film 210 toward the build platform 208. In the illustrated embodiment, the build platform 208 is located below the printer assembly 202. In other embodiments, however, the build platform 208 can be positioned at a different location in the printer assembly 202. The distance between the carrier film 210 and build platform 208 can be adjustable so that the curable material 206 at can be brought into direct contact with the surface of the build platform 208 (when printing the initial layer of the object 204) or with the surface of the object 204 (when printing subsequent layers of the object 204). For example, the build platform 208 can include or be coupled to a motor (not shown) that raises and/or lowers the build platform 208 to the desired height during the manufacturing process.

The printer assembly 202 includes an energy source 218 (e.g., a projector or light engine) that outputs energy 220 (e.g., light, such as UV light) having a wavelength configured to partially or fully cure the curable material 206. The carrier film 210 can be partially or completely transparent to the wavelength of the energy 220 to allow the energy 220 to pass through the carrier film 210 and onto the portion of the curable material 206 above the build platform 208. Optionally, a transparent plate 222 can be disposed between the energy source 218 and the carrier film 210 to guide the carrier film 210 into a specific position (e.g., height) relative to the build platform 208. During operation, the energy 220 can be patterned or scanned in a suitable pattern onto the curable material 206, thus forming a layer of cured material onto the build platform 208 and/or on a previously formed portion of the object 204. The geometry of the cured material can correspond to the desired cross-sectional geometry for the object 204. The parameters for operating the energy source 218 (e.g., energy intensity, energy dosage, exposure time, exposure pattern, exposure wavelength, energy density, power density) can be set based on instructions from a controller 224, as described in further detail below.

Once the object cross-section has been formed, the build platform 208 can be lowered by a predetermined amount to separate the cured material from the carrier film 210. The remaining curable material 206 can be carried by the carrier film 210 away from the build platform 208 and back toward the material source 216. The material source 216 can deposit additional curable material 206 onto the carrier film 210 and/or smooth the curable material 206 to re-form a uniform layer of curable material 206 on the carrier film 210. The curable material 206 can then be recirculated back to the build platform 208 to fabricate an additional layer of the object 204. This process can be repeated to iteratively build up individual object layers on the build platform 208 until the object 204 is complete. The object 204 and build platform 208 can then be removed from the system 200 for post-processing.

In some embodiments, the system 200 is used in a high temperature lithography process utilizing a highly viscous curable material 206 (e.g., a highly viscous resin). Accordingly, the printer assembly 202 can include one or more heat sources (heating plates, infrared lamps, etc.) for heating the curable material 206 to lower the viscosity to a range suitable for additive manufacturing. For example, the printer assembly 202 can include a first heat source 226a positioned against the segment of the carrier film 210 before the build platform 208, and a second heat source 226b positioned against the segment of the carrier film 210 after the build platform 208. Alternatively, or in combination, the printer assembly 202 can include heat sources at other locations.

The system 200 also includes a controller 224 (shown schematically) that is operably coupled to the printer assembly 202 and build platform 208 to control the operation thereof. The controller 224 can be or include a computing device including one or more processors and memory storing instructions for performing the additive manufacturing operations described herein. For example, the controller 224 can receive a digital data set (e.g., a three-dimensional model) representing the object 204 to be fabricated, determine a plurality of object cross-sections to build up the object 204 from the curable material 206, and can transmit instructions to the energy source 218 to output energy 220 to form the object cross-sections. As described above and in greater detail below, the controller 224 can control the energy application parameters of the energy source 218, such as the energy intensity, energy dosage, exposure time, exposure pattern, energy wavelength, and/or energy type of the energy 220 applied to the curable material 206. Optionally, the controller 224 can also determine and control other operational parameters, such as the positioning of the build platform 208 (e.g., height) relative to the carrier film 210, the movement speed and direction of the carrier film 210, the amount of curable material 206 deposited by the material source 216, the thickness of the material layer on the carrier film 210, and/or the amount of heating applied to the curable material 206.

Although FIG. 2 illustrates a representative example of a system 200 for additive manufacturing, this is not intended to be limiting, and the methods described herein can be implemented using other types of additive manufacturing systems, such as material jetting systems, binder jetting systems, material extrusion systems, powder bed fusion systems, sheet lamination systems, or directed energy deposition systems.

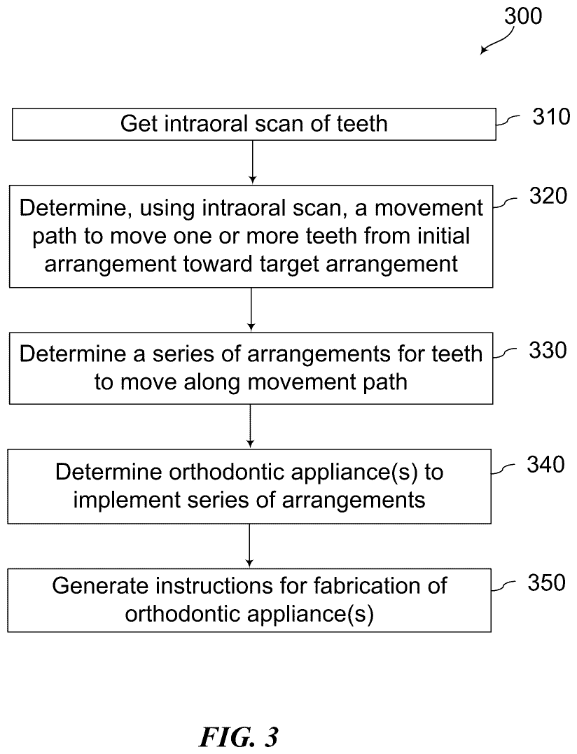

FIG. 3 illustrates a method 300 for designing an orthodontic appliance to be produced by direct fabrication, in accordance with embodiments. The method 300 can be applied to any embodiment of the orthodontic appliances described herein. Some or all of the steps of the method 300 can be performed by any suitable data processing system or device, e.g., one or more processors configured with suitable instructions.

In step 310, an intraoral scan is performed.

In step 320, using the intraoral scan, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions.

In step 330, a series of arrangements for teeth to move along the movement path is determined. The movement path can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In step 340, a determination of orthodontic appliance(s) configured to implement the series of arrangement is determined. Determination of the appliance design, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more appliance designs can be selected for testing or force modeling. As noted above, a desired tooth movement, as well as a series of arrangements required or desired for the tooth movement, can be identified. Using the simulation environment, a candidate appliance design can be analyzed or modeled for determination of an actual moving arrangement resulting from use of the candidate appliance. One or more modifications can optionally be made to a candidate appliance, and arrangements can be further analyzed as described, e.g., in order to iteratively determine an appliance design that produces the desired moving arrangements.

In step 350, instructions for fabrication of the orthodontic appliance incorporating the appliance design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Method 300 may comprise additional steps: 1) The upper arch and palate of the patient is scanned intraorally to generate three dimensional data of the palate and upper arch; 2) The three dimensional shape profile of the appliance is determined to provide a gap and teeth engagement structures as described herein.

Although the above steps show a method 300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 300 may be performed with any suitable fabrication system or device, such as the embodiments described herein. Some of the steps may be optional, and the order of the steps can be varied as desired.

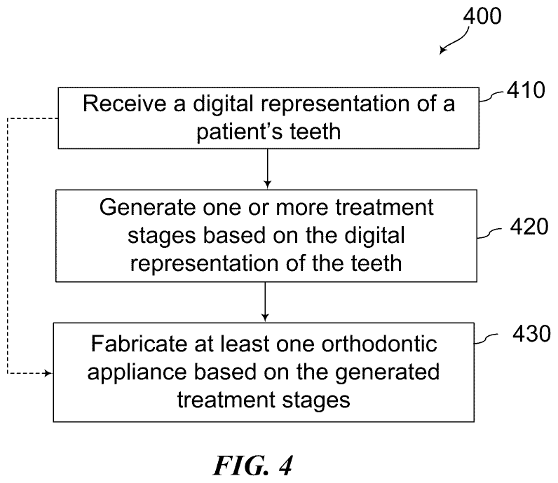

FIG. 4 illustrates a method 400 for digitally planning an orthodontic treatment and/or design or fabrication of an appliance, in accordance with embodiments. The method 400 can be applied to any of the treatment procedures described herein and can be performed by any suitable data processing system.

In step 410, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 420, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 430, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 4, design and/or fabrication of an orthodontic appliance, and perhaps a particular orthodontic treatment, may include use of a representation of the patient's teeth (e.g., receive a digital representation of the patient's teeth), followed by design and/or fabrication of an orthodontic appliance based on a representation of the patient's teeth in the arrangement represented by the received representation.

### Methods of IR Laser Marking of Devices

In one aspect, a method for marking an orthodontic appliance is provided. During the marking process, a portion of the orthodontic appliance comprising a polymeric material formed from a polymerizable resin composition of the present disclosure is exposed to a laser beam of an infrared laser for a period of time, causing a color change of the polymeric material in the exposed portion. The exposing process can be repeated until a mark with a sufficient contrast is formed in the exposed portion of the orthodontic appliance.

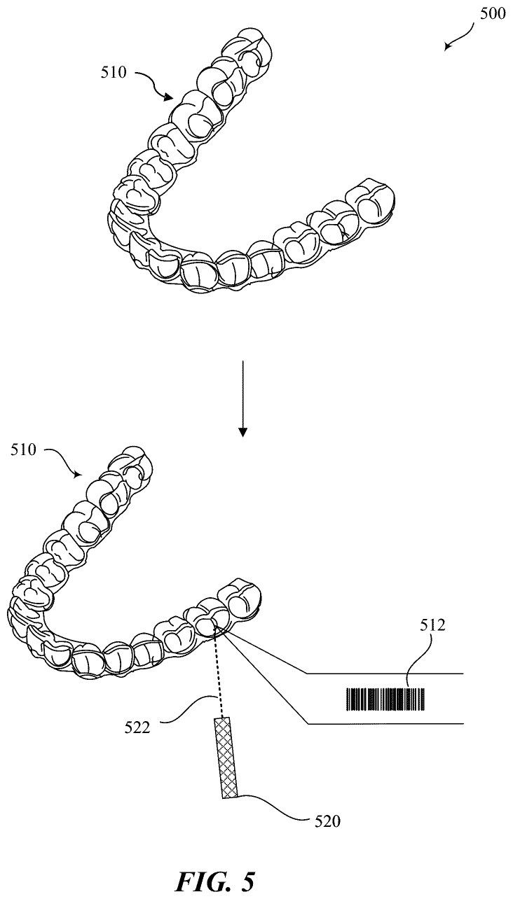

FIG. 5 illustrated a process 500 for marking an orthodontic appliance 510 that is fabricated from a polymerizable resin composition of the present disclosure, in accordance with some embodiments. In some embodiments, the orthodontic appliance 510 may be formed from polymerizable resin composition by 3D printing using a 3D printer, for example, system 200 of FIG. 2. The orthodontic appliance 510 contains IR absorbing marking additives to improve the IR laser markability. During the marking process 500, a light source 520 may emit light 522 onto the surface of the orthodontic appliance 510. The light source 520 may be a laser operated at a wavelength in the IR region ranging from about 700 nm to 10.6 μm. In some embodiments, the light source 520 may have an emission wavelength from 700 nm to 2000 nm. Examples of lasers may include solid-state lasers, diode or diode array lasers, yttrium aluminum garnet (YAG) lasers, fiber lasers, carbon dioxide (CO₂) lasers, and the like. The light source 520 may be operated in a pulsed mode or a continuous mode. For example, the light may be emitted by a solid-state laser, including yttrium orthovanadate (Nd:YVO₄), yttrium lithium fluoride (Nd:YLF) and yttrium aluminum garnet (Nd:YAG), which operates in the infrared spectrum at around 1064 nm. The light 522 may be emitted at wavelengths where the IR absorbing marking additive has the high absorbance such that the light absorbed by the IR absorbing marking additive causes localized heating and color change in the exposed portions of the orthodontic appliance 510, thereby forming a marking 512 in the target region. The marking 512 may include identification information such as numerical numbers, alphanumeric sequence, graphic signs, etc. In some embodiments, the light 522 may be emitted from a YAG laser operating at a wavelength about 1060 nm to 1070 nm. In some embodiments, the light 522 may have a fluence ranging from 0.1 mJ/mm² to 1 mJ/mm². In some embodiments, the light 522 has a fluence of 0.3 mJ/mm².

The light source 520 may be moved until the marking 512 is completed. For example, the light source 520 may be moved in accordance with marking instructions or the orthodontic appliance 510 may be moved relative to the light source 520 in accordance to marking instructions.

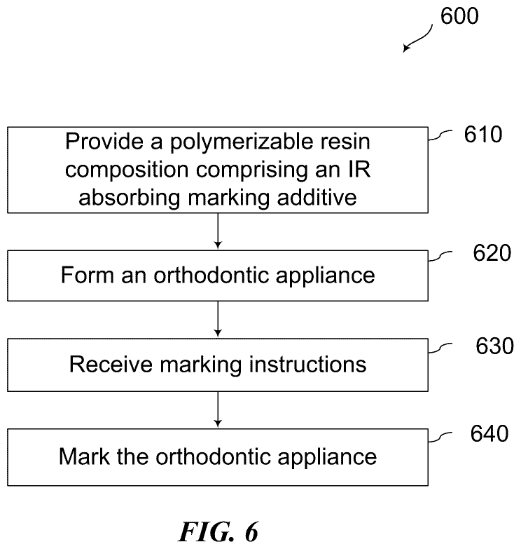

FIG. 6 illustrates a flowchart of a method 600 for producing a marked orthodontic appliance, in accordance with some embodiments.

In step 610, a polymerizable resin composition that is compatible with the 3D printing process is provided. In some embodiments, the polymerizable resin composition comprises a toughness modifier, a reactive diluent, and an IR absorbing marking additive for improving IR laser marking performance of the orthodontic appliance.

In step 620, an orthodontic appliance is formed from the polymerizable resin composition by 3D printing.

In step 630, marking instructions associated with marking of the orthodontic appliance are received. The mark formed on the orthodontic appliance may be a numerical number, an alphanumeric text, a graphic, an image, or any combination thereof. The mark may include identification information, product information, and the like. The mark may be a bar code or a QR code that can be scanned by a reader.

In step 640, the orthodontic appliance is marked by exposing portions of a surface of orthodontic appliance to a laser beam. When the laser beam hits the orthodontic appliance, the IR absorbing marking additive and the reactive diluent absorb the energy, which causes localized heating. The heat breaks chemical bonds of the cured resin, causing the color change in the exposed portions of the orthodontic appliance. In some embodiments, step 640 may be repeated until the mark is formed on the surface of the orthodontic appliance with sufficient contrast.

### On-Track Treatment

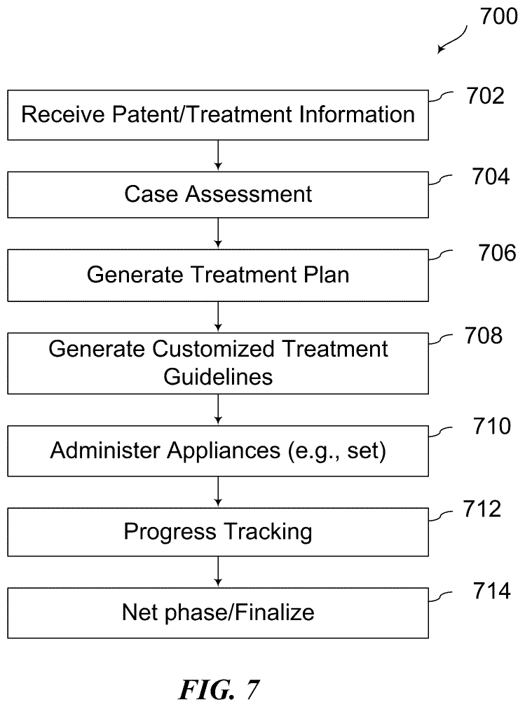

Referring to FIG. 7, a process 700 according to the present invention is illustrated. Individual aspects of the process are discussed in further detail below. The process includes receiving information regarding the orthodontic condition of the patient and/or treatment information (702), generating an assessment of the case (704), and generating a treatment plan for repositioning a patient's teeth (706). Briefly, a patient/treatment information will include obtaining data comprising an initial arrangement of the patient's teeth, which typically includes obtaining an impression or scan of the patient's teeth prior to the onset of treatment and can further include identification of one or more treatment goals selected by the practitioner and/or patient. A case assessment can be generated (704) so as to assess the complexity or difficulty of moving the particular patient's teeth in general or specifically corresponding to identified treatment goals and may further include practitioner experience and/or comfort level in administering the desired orthodontic treatment. In some cases, however, the assessment can include simply identifying particular treatment options (e.g., appointment planning, progress tracking, etc.) that are of interest to the patient and/or practitioner. The information and/or corresponding treatment plan will include identifying a final or target arrangement of the patient's teeth that is desired, as well as a plurality of planned successive or intermediary tooth arrangements for moving the teeth along a treatment path from the initial arrangement toward the selected final or target arrangement.

The process further includes generating customized treatment guidelines (708). The treatment plan typically includes multiple phases of treatment, with a customized set of treatment guidelines generated that correspond to a phase of the treatment plan. The guidelines will include detailed information on timing and/or content (e.g., specific tasks) to be completed during a given phase of treatment and will be of sufficient detail to guide a practitioner, including a less experienced practitioner or practitioner relatively new to the particular orthodontic treatment process, through the phase of treatment. Since the guidelines are designed to specifically correspond to the treatment plan and provide guidelines on activities specifically identified in the treatment information and/or generated treatment plan, the guidelines are said to be customized. The customized treatment guidelines are then provided to the practitioner so as to help instruct the practitioner as how to deliver a given phase of treatment. As set forth above, appliances can be generated based on the planned arrangements and will be provided to the practitioner and ultimately administered to the patient (710). The appliances are typically provided and/or administered in sets or batches of appliances, such as 2, 3, 4, 5, 6, 7, 8, 9, or more appliances, but are not limited to any particular administrative scheme. Appliances can be provided to the practitioner concurrently with a given set of guidelines, or appliances and guidelines can be provided separately.

After the treatment according to the plan begins and following administration of appliances to the patient, treatment progress tracking, e.g., by teeth matching, is done to assess a current and actual arrangement of the patient's teeth compared to a planned arrangement (712). If the patient's teeth are determined to be “on-track” and progressing according to the treatment plan, then treatment progresses as planned and treatment progresses to the next stage of treatment (714). If the patient's teeth have substantially reached the initially planned final arrangement, then treatment progresses to the final stages of treatment (714). Where the patient's teeth are determined to be tracking according to the treatment plan, but have not yet reached the final arrangement, the next set of appliances can be administered to the patient.

The threshold difference values of a planned position of teeth to actual positions selected as indicating that a patient's teeth have progressed on-track are provided below in Table 1. If a patient's teeth have progressed at or within the threshold values, the progress is considered to be on-track. If a patient's teeth have progressed beyond the threshold values, the progress is considered to be off-track.

TABLE 1

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The patient's teeth are determined to be on track by comparison of the teeth in their current positions with teeth in their expected or planned positions, and by confirming the teeth are within the parameter variance disclosed in Table 1. If the patient's teeth are determined to be on track, then treatment can progress according to the existing or original treatment plan. For example, a patient determined to be progressing on track can be administered one or more subsequent appliances according to the treatment plan, such as the next set of appliances. Treatment can progress to the final stages and/or can reach a point in the treatment plan where bite matching is repeated for a determination of whether a patient's teeth are progressing as planned or if the teeth are off track.

In some embodiments, as further disclosed herein, this disclosure provides methods of treating a patient using a 3D printed orthodontic appliance. In certain embodiments, the method of repositioning a patient's teeth (or, in some embodiments, a singular tooth) comprises:
generating a treatment plan for the patient, the plan comprising tooth arrangements for moving teeth along a treatment path from an initial arrangement toward a final arrangement;
producing a 3D printed orthodontic appliance comprising less than or equal to 20 wt % hydrogen bonding units or less than or equal to 10 wt % hydrogen bonding units; and
moving on-track, with the orthodontic appliance, at least one of the patient's teeth toward an intermediate arrangement or a final tooth arrangement. In preferred embodiments, the method further comprises achieving on-track the movement of the patient's teeth to the intermediate arrangement or final tooth arrangement. In some embodiments, producing the 3D printed orthodontic appliance uses the polymerizable resin compositions disclosed further herein. On-track performance can be determined, e.g., from Table 1, above.

In some embodiments, the method further comprises tracking the progression of the patient's teeth along the treatment path after administration of the orthodontic appliance. In certain embodiments, the tracking comprises comparing a current arrangement of the patient's teeth to a planned arrangement of the teeth. As a non-limiting example, following the initial administration of the orthodontic appliance, a period of time passes (e.g., two weeks), a comparison of the now-current arrangement of the patient's teeth (i.e., at two weeks of treatment) can be compared with the teeth arrangement of the treatment plan. In some embodiments, the progression can also be tracked by comparing the current arrangement of the patient's teeth with the initial configuration of the patient's teeth. The period of time can be, for example, greater than 3 days, greater than 4 days, greater than 5 days, greater than 6 days, greater than 7 days, greater than 8 days, greater than 9 days, greater than 10 days, greater than 11 days, greater than 12 days, greater than 13 days, greater than 2 weeks, greater than 3 weeks, greater than 4 weeks, or greater than 2 months. In some embodiments, the period of time can be from at least 3 days to at most 4 weeks, from at least 3 days to at most 3 weeks, from at least 3 days to at most 2 weeks, from at least 4 days to at most 4 weeks, from at least 4 days to at most 3 weeks, or from at least 4 days to at most 2 weeks. In certain embodiments, the period of time can restart following the administration of a new orthodontic appliance.

In some embodiments, greater than 50%, greater than 55%, greater than 60%, greater than 65%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99% of the patient's teeth are on track with the treatment plan after a period of time of using an orthodontic appliance as disclosed further herein. In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

### Properties After Use

In some embodiments of the method disclosed above, the 3D printed orthodontic appliance has a retained repositioning force (i.e., the repositioning force after the orthodontic appliance has been applied to or worn by the patient over a period of time), and the retained repositioning force to at least one of the patient's teeth after the period of time is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of the repositioning force initially provided to the at least one of the patient's teeth (i.e., with initial application of the orthodontic appliance). In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

In preferred embodiments, the orthodontic appliances disclosed herein can provide on-track movement of at least one of the patient's teeth. On-track movement has been described further herein, e.g., at Table 1. In some embodiments, the orthodontic appliances disclosed herein can be used to achieve on-track movement of at least one of the patient's teeth to an intermediate tooth arrangement. In some embodiments, the orthodontic appliances disclosed herein can be used to achieve on-track movement of at least one of the patient's teeth to a final tooth arrangement.

In some embodiments, prior to moving on-track, with the orthodontic appliance, at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

As provided herein, the methods disclosed can use the orthodontic appliances further disclosed herein. Said orthodontic appliances can be directly fabricated using, e.g., the resins disclosed herein. In certain embodiments, the direct fabrication comprises cross-linking the resin.

The appliances formed from the resins disclosed herein provide improved durability, strength, and flexibility, which in turn improve the rate of on-track progression in treatment plans. In some embodiments, greater than 60%, greater than 70%, greater than 80%, greater than 90%, or greater than 95% of patients treated with the orthodontic appliances disclosed herein (e.g., an aligner) are classified as on-track in a given treatment stage. In certain embodiments, greater than 60%, greater than 70%, greater than 80%, greater than 90%, or greater than 95% of patients treated with the orthodontic appliances disclosed herein (e.g., an aligner) have greater than 50%, greater than 55%, greater than 60%, greater than 65%, greater than 70%, greater than 75%, greater than 80%, greater than 85%, greater than 90%, or greater than 95% of their tooth movements classified as on-track.

As disclosed further herein, the cured polymeric material contains favorable characteristics that, at least in part, stem from the presence of polymeric crystals. These cured polymeric materials can have increased resilience to damage, can be tough, and can have decreased water uptake when compared to similar polymeric materials. The cured polymeric materials can be used for devices within the field of orthodontics, as well as outside the field of orthodontics. For example, the cured polymeric materials disclosed herein can be used to make devices for use in aerospace applications, automobile manufacturing, the manufacture of prototypes, and/or devices for use in durable parts production.

### Experimental Methods

All chemicals were purchased from commercial sources and were used without further purification, unless otherwise stated.

In some embodiments, the stress relaxation of a material or device can be measured by monitoring the time-dependent stress resulting from a steady strain. The extent of stress relaxation can also depend on the temperature, relative humidity and other applicable conditions (e.g., presence of water). In embodiments, the test conditions for stress relaxation are a temperature of 37±2° C. at 100% relative humidity or a temperature of 37±2° C. in water.

The dynamic viscosity of a fluid indicates its resistance to shearing flows. The SI unit for dynamic viscosity is the Poiseuille (Pa·s). Dynamic viscosity is commonly given in units of centipoise, where 1 centipoise (cP) is equivalent to 1 mPa·s. Kinematic viscosity is the ratio of the dynamic viscosity to the density of the fluid; the SI unit is m^{2/}s. Devices for measuring viscosity include viscometers and rheometers. For example, an MCR 301 rheometer from Anton Paar may be used for rheological measurement in rotation mode (PP-25, 50 s-1, 50-115° C., 3° C./min).

Determining the water content when fully saturated at use temperature can comprise exposing the polymeric material to 100% humidity at the use temperature (e.g., 40° C.) for a period of 24 hours, then determining water content by methods known in the art, such as by weight.

In some embodiments, the presence of a crystalline phase and an amorphous phase provide favorable material properties to the polymeric materials. Property values of the cured polymeric materials can be determined, for example, by using the following methods:
stress relaxation properties can be assessed using an RSA-G2 instrument from TA Instruments, with a 3-point bending, according to ASTM D790; for example, stress relaxation can be measured at 30° C. and submerged in water, and reported as the remaining load after 24 hours, as either the percent (%) of initial load, and/or in MPa;
storage modulus can be measured at 37° C. and is reported in MPa;
T_{g} of the cured polymeric material can be assessed using dynamic mechanical analysis (DMA) and is provided herein as the tan 8 peak;
tensile modulus, tensile strength, elongation at yield and elongation at break can be assessed according to ISO 527-2 5B; and tensile strength at yield, elongation at break, tensile strength, and Young's modulus can be assessed according to ASTM D1708.

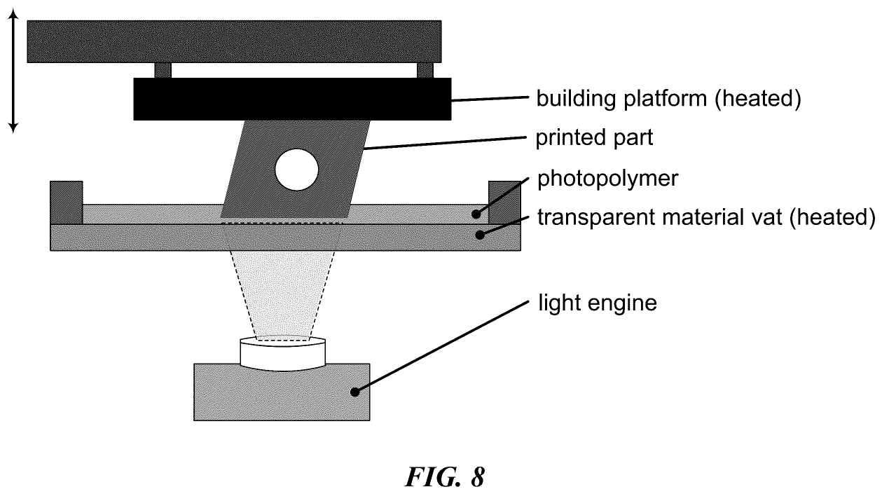

Additive manufacturing or 3D printing processes for generating a device herein (e.g., an orthodontic appliance) can be conducted using a Hot Lithography apparatus prototype from Cubicure (Vienna, Austria), which can substantially be configured as schematically shown in FIG. 8. In such cases, a photopolymerizable composition (e.g., resin) according to the present disclosure can be filled into the transparent material vat of the apparatus shown in FIG. 8, which vat can be heated to 90-110° C. The building platform can be heated to 90-110° C., too, and lowered to establish holohedral contact with the upper surface of the polymerizable composition. By irradiating the composition with 375 nm UV radiation using a diode laser from Soliton, which can have an output power of 70 mW, which can be controlled to trace a predefined prototype design, and alternately raising the building platform, the composition can be cured layer by layer by a photopolymerization process according to the disclosure, resulting in a polymeric material according to present disclosure.

Spectrophotometric Color Analysis. The differences in color between the marked surfaces and the background were determined via colorimetric tests using Konica Minolta CM-26dG Spectrophotometer. All measurements were taken on top of the white part of a Leneta Form 2A Opacity Chart (L*˜93, a*˜−1.5, b*˜3.5). To analyze the results, the CIELAB color space was used, within which the parameters L*, a*, and b* are determined for each measurement area. Measurements were performed on laser-marked surfaces and surfaces of samples before marking (background). The color difference between the surface of the sample before marking and the marked surface was assessed by analyzing the value of the total color deviation (AdE). This parameter was calculated using the following formula:

$$Δ dE *= \sqrt{{{{( Δ L \text{*)}}^{2} + ( Δ a \text{*)}}^{2} + ( Δ b \text{*)}}^{2}}$$

### EXAMPLES

The specific compositions, synthesis, formulations, and descriptions of any of the materials, devices, systems, and components thereof, of the present disclosure can be readily varied depending upon the intended application, as will be apparent to those of skill in the art in view of the disclosure herein. Moreover, it is understood that the examples and aspects described herein are for illustrative purposes only and that various modifications or changes in light thereof can be suggested to persons skilled in the art and are included within the spirit and purview of this application and scope of the appended claims. Numerous different combinations of aspects described herein are possible, and such combinations are considered part of the present disclosure. In addition, all features discussed in connection with any one aspect herein can be readily adapted for use in other aspects herein. The use of different terms or reference numerals for similar features in different aspects does not necessarily imply differences other than those expressly set forth. Accordingly, the present disclosure is intended to be described solely by reference to the appended claims, and not limited to the aspects disclosed herein.

### Example 1

### Laser Markability of Polymerizable Resin Compositions

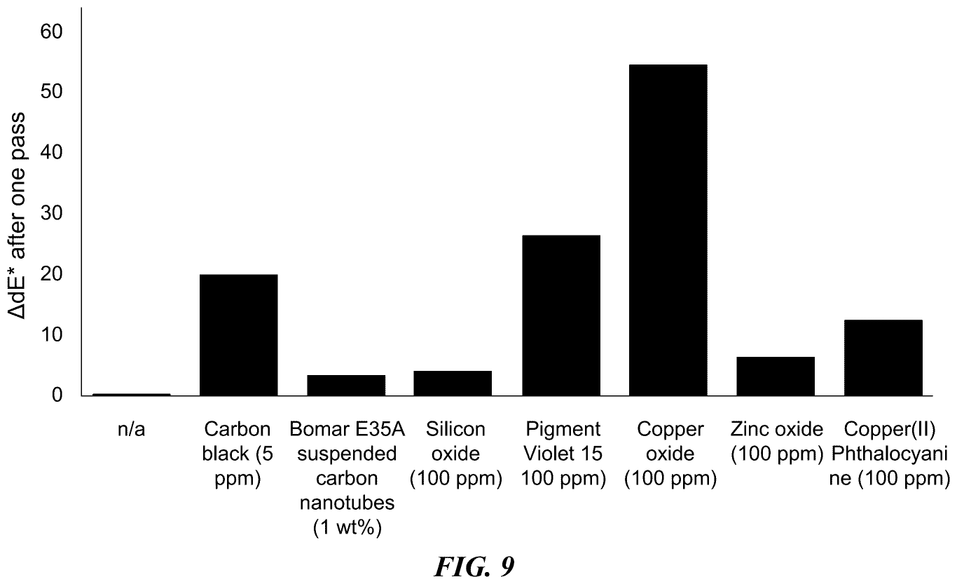

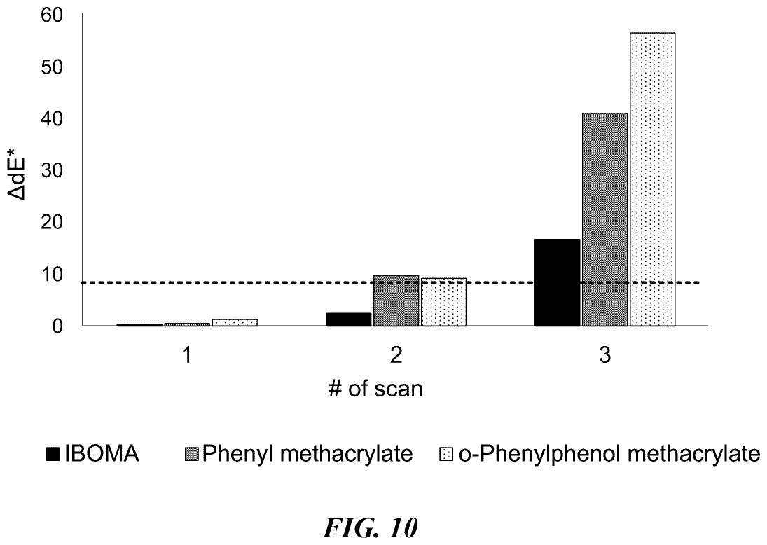

Effects of different IR absorbing additives on the IR laser markability of polymeric materials formed from polymerizable resin compositions of the present disclosure were evaluated. The resin matrix in each polymerizable resin composition tested was comprised of 50 wt % Bomar BR 543 MB (a dendritic acrylate oligomer) and 50 wt % reactive diluent. Each polymerizable resin composition further includes 2 wt % TPO as the photoinitiator and an IR absorbing marking additive. The differences in color between the marked surfaces and the background of each polymeric material after IR laser marking were determined by colorimetric tests. The compositions and average color change values (ΔdE*) for different IR absorbing marking additives and different reactive diluents are summarized in Table 2. Single scan (i.e., single pass) or multiple scans were performed on resin matrixes with or without any IR absorbing marking additives, respectively. For each scan, the laser energy was 0.3 mJ/mm² dosage. FIG. 9 illustrates laser marking color difference values of compositions with different IR absorbing marking additives. The color difference values of the compositions are compared with the color difference value of a control composition comprising silicon oxide as an IR absorbing marking additive. FIG. 10 illustrates laser marking color difference values of compositions with reactive diluents of different conjugation length after one, two or three scans.

TABLE 2
Laser Markability of Polymerizable Resin Compositions

Matrix

| Reactive Diluent | Marking Additive | ΔdE* | | |
|---|---|---|---|---|
| (50 wt %) | (ppm) | Scan 1 | Scan 2 | Scan 3 |
| Isobornyl methacrylate | n/a | 0.21 | 2.64 | 16.99 |
| Isobornyl methacrylate | Carbon black | 20.4 | | |
| | (5 ppm) | | | |
| Isobornyl methacrylate | Copper oxide | 54.53 | | |
| | (100 ppm) | | | |
| Isobornyl methacrylate | Copper(II) | 13.38 | | |
| | phthalocyanine | | | |
| | (100 ppm) | | | |
| Isobornyl methacrylate | Zinc oxide | 6.76 | | |
| | (100 ppm) | | | |
| Isobornyl methacrylate | Pigment Violet 15 | 26.63 | | |
| | (100 ppm) | | | |
| Isobornyl methacrylate | Bomar E35A | 3.65 | | |
| | suspended | | | |
| | carbon nanotubes | | | |
| | (1 wt %) | | | |
| Isobornyl methacrylate | Silicon oxide | 4.31 | | |
| | (100 ppm) | | | |
| Phenyl methacrylate | n/a | 0.5 | 9.98 | 41.21 |
| Biphenyl methacrylate | n/a | 1.5 | 9.47 | 56.83 |

As used in Table 2 above and through this disclosure,
isobornyl methacrylate (IBOMA) has the following structure:

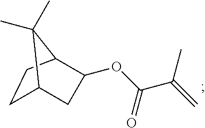

phenyl methacrylate has the following structure:

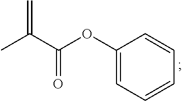

and
biphenyl methacrylate has the following structure:

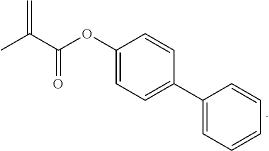 [SMILES: C=C(C)C(=O)Oc1ccc(-c2ccccc2)cc1]

The coloration analysis revealed that the presence of IR absorbing marking additives in the polymerizable resin composition can greatly increase the extent of color change of the cured resins. All of the polymerizable resin compositions comprising IR absorbing marking additives show increased color change compared to a pristine polymerizable resin composition without any IR absorbing marking additives. The effect was obtained mainly due to the increase of the absorbance in the IR region. Additionally, using a reactive diluent with a conjugated aromatic pendant group also leads to increased color change (i.e., enhanced markability). For example, the polymerizable resin composition using phenyl methacrylate or biphenyl methacrylate as the reactive diluent shows increased color change compared to the polymerizable resin composition using an aliphatic methacrylate (i.e., isobornyl methacrylate) as the reactive diluent, indicating the increased IR laser markability. The color change is more significant as the conjugation length of the reactive diluent is increased. As shown in Table 2, when biphenyl methacrylate is used as the reactive diluent, the color change (ΔdE*) of the cured composition after single pass is 1.5, which is three times of the color change (ΔdE*) of the cured composition when phenyl methacrylate is used as the reactive diluent

### Example 2

### Treatment Using an Orthodontic Appliance

This example describes the use of a directly 3D printed orthodontic appliance to move a patient's teeth according to a treatment plan. This example also describes the characteristics that the orthodontic appliance can have following its use, in contrast to its characteristics prior to use.

A patient in need of, or desirous of, a therapeutic treatment to rearrange at least one tooth has their teeth arrangement assessed. An orthodontic treatment plan is generated for the patient. The orthodontic treatment plan comprises a plurality of intermediate tooth arrangements for moving teeth along a treatment path, from the initial arrangement (e.g., that which was initially assessed) toward a final arrangement. The treatment plan includes the use of an orthodontic appliance, fabricated using polymerizable resin compositions and methods disclosed further herein, to provide orthodontic appliances having low levels of hydrogen bonding units. In some embodiments, a plurality of orthodontic appliances are used, each of which can be fabricated using the polymerizable resin compositions and methods disclosed further herein.

The orthodontic appliances are provided, and iteratively applied to the patient's teeth to move the teeth through each of the intermediate tooth arrangements toward the final arrangement. The patient's tooth movement is tracked. A comparison is made between the patient's actual teeth arrangement and the planned intermediate arrangement. Where the patient's teeth are determined to be tracking according to the treatment plan, but have not yet reached the final arrangement, the next set of appliances can be administered to the patient. The threshold difference values of a planned position of teeth to actual positions selected as indicating that a patient's teeth have progressed on-track are provided above in Table 1. If a patient's teeth have progressed at or within the threshold values, the progress is considered to be on-track. Favorably, the use of the appliances disclosed herein increases the probability of on-track tooth movement.

The assessment and determination of whether treatment is on-track can be conducted, for example, 1 week (7 days) following the initial application of an orthodontic appliance. Following this period of application, additional parameters relating to assessing the durability of the orthodontic appliance can also be conducted. For example, relative repositioning force (compared to that which was initially provided by the appliance), remaining flexural stress, relative flexural modulus, and relative elongation at break can be determined.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheetare incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A polymerizable resin composition for forming an orthodontic appliance by additive manufacturing, the polymerizable resin composition comprising:
a telechelic compound comprising:
an oligomeric or a polymeric chain of interconnected monomeric units having a first terminal end and a second terminal end, wherein the oligomeric or polymeric chain is selected from the group consisting of (poly)carbonate-(poly)urethane, (poly)ester-(poly)urethane, (poly)ether-(poly)urethane, (poly)thioether-(poly)urethane, hydrogenated (poly)butadiene, (poly)ester and (poly)urethane;
at least one first reactive functional group covalently bonded to the first terminal end; and
at least one second reactive functional group covalently bonded to the second terminal end;
a reactive diluent; and
an infrared absorbing marking additive.

2. The composition of claim 1, wherein the reactive diluent is an aliphatic or cycloaliphatic (meth)acrylate compound.

3. The composition of claim 1, wherein the reactive diluent is 2-ethylhexyl methacrylate (EHMA), 2-cyanoethyl methacrylate (CEMA), cyclohexyl methacrylate or isobornyl methacrylate (IBOMA).

4.-5. (canceled)

6. The composition of claim 1, wherein the reactive diluent is a compound of Formula (III): 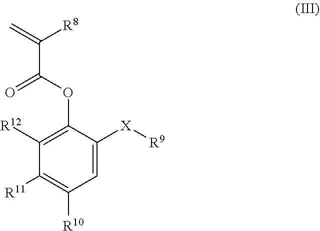
wherein:
X is O, S, NR¹³, or SiR¹⁴R¹⁵;
R⁸ is H, C₁₋₃ alkyl or halogen;
R⁹ is H, C₁₋₆ alkyl, C₁₋₆ heteroalkyl, C₁₋₆ carbonyl, C₁₋₆ carboxy, cyclo(C₃₋₈) alkyl, cyclo(C₃₋₈) heteroalkyl, aryl or heteroaryl;
R¹⁰ is H or aryl;
R¹¹ and R¹² are each independently H, C₁₋₆ alkyl, C₁₋₆ heteroalkyl, C₁₋₆ alkoxy, C₁₋₆ thioalkoxy, C₁₋₆ carbonyl, C₁₋₆ carboxy, or —Y—(CH₂)ₙ—R¹⁶; or R¹¹ and R¹² together form aryl or heteroaryl;
Y is O, S, NH orC(O)O;
n is an integer from 0 to 6;
R¹³, R¹⁴, and R¹⁵ are independently, H or C₁₋₆ alkyl; and
R¹⁶ is cyclo(C₃₋₈) alkyl, cyclo-(C₃₋₈) heteroalkyl, aryl or heteroaryl.

7. The composition of claim 6, wherein the reactive diluent has one of the following structures:

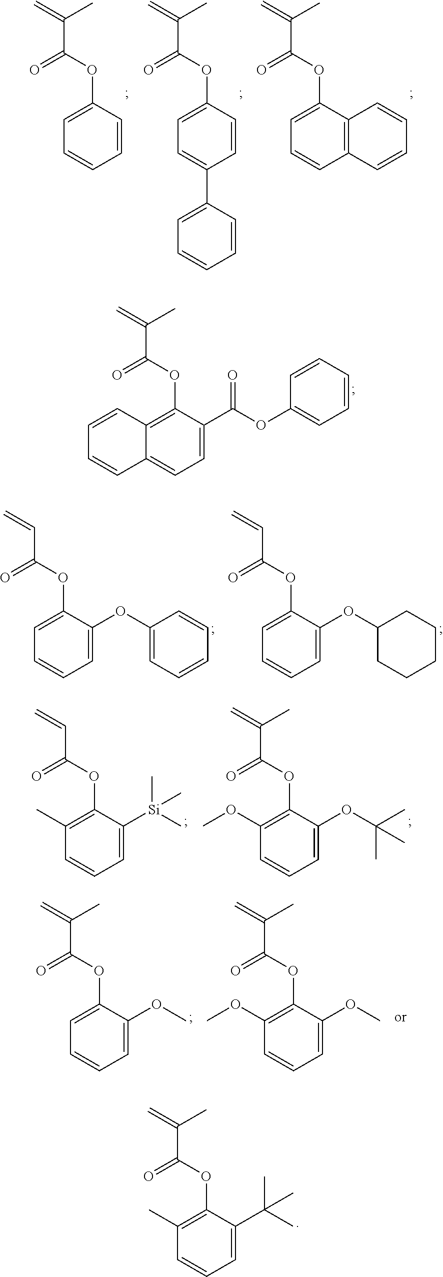

8. (canceled)

9. The composition of claim 1, wherein the infrared absorbing marking additive comprises a silicate, a metal silicate, a carbon-based calcined material, a metal oxide, a transition metal hydroxide, a metal carbonate, a metal complex, or a zeolite nanoparticle.

10. The composition of claim 9, wherein the infrared absorbing marking additive is a metal oxide selected from the group consisting of copper oxide, chromium oxide, iron oxide, zinc oxide, tungsten oxide, molybdenum oxide and combinations thereof.

11. The composition of claim 9, wherein the infrared absorbing marking additive is a metal complex selected from the group consisting of copper phthalocyanine, zinc phthalocyanine, magnesium phthalocyanine, nickel phthalocyanine, iron phthalocyanine and combinations thereof.

12. The composition of claim 9, wherein the infrared absorbing marking additive is a carbon-based calcined material selected from the group consisting of carbon black, graphene, carbon nanotube and combinations thereof.

13. The composition of claim 1, wherein the at least one first reactive functional group and the at least one second reactive functional group is selected from acrylate, methacrylate, vinyl acrylate, vinyl methacrylate, allyl ether, silene, alkyne, alkene, vinyl ether, maleimide, fumarate, maleate, itaconate, vinyl ester, vinyl ketone, epoxide, oxetane, cyclic ester, and styrenyl.

14.-15. (canceled)

16. The composition of claim 13, wherein the telechelic compound has one of the following structures: 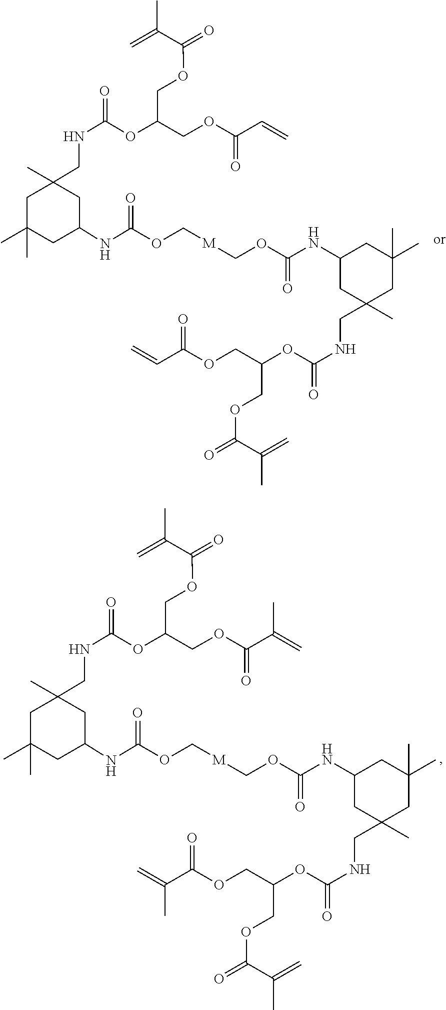
wherein:
M is an oligomeric or polymeric chain of interconnected monomeric units selected from the group consisting of (poly)carbonate-(poly)urethane, (poly)ester-(poly)urethane, (poly)ether-(poly) urethane, (poly)thioether-(poly)urethane, hydrogenated (poly)butadiene, (poly)ester and (poly)urethane.

17.-24. (canceled)

25. The composition of claim 1, wherein the polymerizable resin composition comprises 1 to 1,000 ppm, based on the total weight of the composition, of the infrared absorbing marking additive.

26. The composition of claim 25, wherein the polymerizable resin composition comprises 1 to 400 ppm, based on the total weight of the composition, of the infrared absorbing marking additive.

27. (canceled)

28. The composition of claim 2726, wherein the polymerizable resin composition comprises 5 to 100 ppm, based on the total weight of the composition, of the infrared absorbing marking additive.

29.-36. (canceled)

37. The composition of claim 1, wherein the polymerizable resin composition is capable of being 3D printed at a printing temperature greater than 25° C.

38. (canceled)

39. The composition of claim 1, wherein the polymerizable resin composition has a viscosity from 30 cP to 50,000 cP at a printing temperature.

40.-43. (canceled)

44. A polymeric material formed from the polymerizable resin composition of claim 1.

45.-64. (canceled)

65. An orthodontic appliance comprising a polymeric material formed from a polymerizable resin composition of claim 1, wherein the orthodontic appliance comprises a marking area comprising a laser mark.

66.-87. (canceled)

88. A method of marking an orthodontic appliance, comprising:
exposing a portion of the orthodontic appliance comprising a polymeric material formed from a polymerizable resin composition of claim 1 to a laser beam of an infrared laser for a first period of time,
wherein the polymeric material having an initial color dE*, and
wherein exposing causes a color change of the polymeric material in the exposed portion, thereby forming a mark in the exposed portion of the orthodontic appliance.

89.-96. (canceled)

97. The method of claim 88, further comprising forming the orthodontic appliance by additive manufacturing, wherein forming the orthodontic appliance comprises:
exposing the polymerizable resin composition to an ultraviolet (UV) light source;
polymerizing the polymerizable resin composition to form the polymeric material; and
fabricating the orthodontic appliance with the polymeric material,
wherein the IR absorbing marking additive does not absorb the UV radiation.

98.-113. (canceled)
